(19) United States
(12) Patent Application Publication
(10) Pub. No.: US 2024/0325232 A1
(43) Pub. Date: Oct. 3, 2024

(54) IMPROVED SAFETY FEATURES FOR TACTILE PROFILES

(71) Applicant: I-GLO LIMITED, Northumberland (GB)

(72) Inventor: David Wagstaff, Northumberland (GB)

(73) Assignee: I-GLO LIMITED, Northumberland (GB)

(21) Appl. No.: 18/694,579

(22) PCT Filed: Sep. 23, 2022
(86) PCT No.: PCT/GB2022/052420

§ 371 Date: Mar. 22, 2024

(30) Foreign Application Priority Data
Sep. 24, 2021 (GB) 2113743.5

(51) Int. Cl. A61H 3/06

(52) U.S. Cl. CPC A61H 3/066; A61H 2201/0188; A61H 2201/169

(57) ABSTRACT

Disclosed herein is a tactile floor surface comprising one or more tactile profiles protruding from the floor surface, each tactile profile comprising: a first layer, and a second layer positioned over the first layer, wherein the first layer has a visibly distinguishable property such that, in use, when the second layer wears away, the visibly distinguishable property is revealed.

### TECHNICAL FIELD

The present invention relates to improved installation and safety features for tactile paving.

### BACKGROUND

Various scales have been developed to describe the extent of vision loss and to define what is meant by blindness. Total blindness is the complete lack of form and light perception. Despite the fact that there are many people registered as being blind, only 5% of those afflicted by blindness have no light perception at all, which means that around 95% of registered blind people have light perception and some residual sight.

Government legislation exists which ensures that those having visual impairment have access to the goods and services that sighted people have access to, thereby maintaining their independence and quality of life.

It is known to provide flooring having different textures in order to convey messages to visually impaired people, as well as providing orientation assistance and warning them about hazards.

One example of this is the use of tactile surfaces, for example, concrete blisters, which are commonplace in pedestrianised areas. The contrast in surface profile and texture provided by the concrete blisters act as a means for warning visually impaired people that they are approaching a dropped kerb on a pavement, for example.

The domes are of sufficient height (normally greater than 5.5 mm) to ensure that they are identified underfoot. Under constant pedestrian traffic the raised domes are worn down until they reach a height at which they are not easily identified underfoot (normally below 3 mm). Below this height the visually impaired have great difficulty in identifying the presence of tactile surfaces.

When tactile profiles become worn the only available solution currently is to replace the complete tactile surface. This not only creates a waste problem but also contributes to the carbon footprint by requiring more concrete tactiles, for example to be manufactured. The process is unsustainable and results in a depletion of natural resources.

It is also known to utilise contrasts in colour to accentuate the presence of a tactile surface, enabling visually impaired people to use their residual vision to obtain information about their surroundings.

Despite being a commonly used means for conveying information to visually impaired people, the use of contrasts in colour as described above suffers from the disadvantage that it does not provide any real guidance to visually impaired or normal sighted people at night, or in the event of darkness for any other reason, such as an emergency situation, since in those circumstances there is no light available for visually impaired people to be able to use their residual sight in order to distinguish contrasting colours.

Installation of surface mounted tactile tiles have become more cost effective than traditional concrete paving slabs as no excavation is required negating the high costs of the associated plant and machinery hire charges. Adhesive systems are required to bond the surface mounted tactile to the floor surface area to which it is applied. However most adhesive systems suffer in adverse weather conditions, such as wet and cold weather, reducing the adhesive strength, which can lead to delamination of the tactile tile further down the line.

The aim of the present invention is to overcome, or at least alleviate, where possible, the above mentioned disadvantages of the prior art and in particular to provide an improved tactile surface which is able to be installed in inclement weather without the loss of adhesive performance; is able to alert maintenance or building owners when the tactile profiles have worn down to an undetectable level of less than 3 mm through a change of colour; is able to be topped up in-situ to a detectable level when worn from pedestrian traffic, and is also visible at night or in subdued lighting to both the normal sighted and visually impaired.

### SUMMARY OF THE INVENTION

In accordance with a first aspect of the invention there is provided a tactile floor surface comprising one or more tactile profiles protruding from the floor surface, each tactile profile comprising: a first layer, and a second layer positioned over the first layer, wherein the first layer has a visibly distinguishable property such that, in use, when the second layer wears away, the visibly distinguishable property is revealed.

Optionally, the first layer of each tactile profile protrudes a first predetermined amount above the floor surface.

Optionally, the first predetermined amount is such that each tactile profile is substantially detectable under foot.

Optionally, the first predetermined amount is a distance of approximately 3 mm above the floor surface.

Optionally, the visibly distinguishable property is a colour which is different from a colour of the second layer.

Optionally, either, or both, the first layer and the second layer comprise a polymer either with or without an aggregate.

Optionally, the polymer comprises polyurethane.

Optionally, the aggregate comprises glass beads, aluminium oxide, or quartz either individually or as a mix.

Optionally, the tactile floor surface is a tactile tile.

Optionally, the tactile tile is a surface mountable tactile tile.

Optionally, the one or more tactile profiles are blister profiles.

Optionally, the one or more tactile profiles are corduroy profiles.

Optionally, the one or more tactile profiles are guidance profiles.

Optionally, the one or more tactile profiles are configured to be used in conjunction with a segregated path comprising a foot path and a cycle track.

Optionally, the one or more tactile profiles are configured to highlight the cycle track.

Optionally, the second layer of one or more of the one or more tactile profiles comprises glow-in-the-dark material.

Optionally, the one or more tactile profiles comprising glow-in-the-dark material are arranged to indicate a pathway on the floor surface.

Optionally, the one or more tactile profiles comprising the glow-in-the-dark material are arranged to indicate hazards such as a platform edge, a cycle route, or a change in height of a floor surface.

In accordance with a second aspect of the invention there is provided a tactile profile for use in a floor surface in accordance with the first aspect, the tactile profile arranged to protrude from a floor surface, said tactile profile comprising: a first layer, and a second layer positioned over the first layer, wherein the first layer has a visibly distinguishable property such that, in use, when the second layer wears away, the visibly distinguishable property is revealed.

In accordance with a third aspect of the invention there is provided a method of manufacturing a tactile floor surface comprising one or more tactile profiles protruding from the floor surface, each tactile profile comprising: a first layer, and a second layer positioned over the first layer, wherein the first layer has a visibly distinguishable property such that, in use, when the second layer wears away, the visibly distinguishable property is revealed, wherein the method comprises: forming a first layer, and forming a second layer; such that the second layer is positioned over the first layer.

Optionally, the method comprises: using an open topped mould, the open topped mould comprising one or more cavities, each cavity shaped to correspond with a tactile profile of the one or more tactile profiles of the tactile floor surface, the method further comprising: partially filling the open topped mould with a first liquid mixture; after a predetermined period of time, filling the open topped mould with a second liquid mixture on top of the first liquid mixture, the predetermined period of time of a duration such that the second liquid mixture cross-links with the first liquid mixture during curing but such that the second liquid mixture does not overcome the surface resistance of the first liquid mixture, wherein the second liquid mixture, when cured, forms the first layer of the one or more tactile profiles, and the first liquid mixture, when cured, forms the second layer of the one or more tactile profiles; allowing the first liquid mixture and the second liquid mixture to cure thereby forming the tactile floor surface.

Optionally, the method further comprises filling the open topped mould with a first predetermined volume of the first liquid mixture and a second predetermined volume of the second liquid mixture such that the first layer of each resulting tactile profile protrudes by a first predetermined amount above the floor surface.

Optionally, the method further comprises including a pigment in the second liquid mixture such that the resulting first layer is a colour which is different from a colour of the resulting second layer thereby providing the visibly distinguishable property.

Optionally, the predetermined period of time is approximately 20 minutes.

In accordance with a fourth aspect of the invention there is provided a method of reinstating one or more worn tactile profiles protruding from a tactile floor surface to a pre-worn form using a mould, the mould comprising a plurality of cavities, each cavity shaped to correspond with a tactile profile in its pre-worn form, each cavity comprising an aperture through which a liquid mix can be transferred into the cavity, the method comprising: aligning the mould with the floor surface such that each worn tactile profile is located within a corresponding cavity of the mould; filling each cavity through an aperture with a liquid mix, the liquid mix configured to, when curing, adhere to the surface of the worn tactile profile thereby forming reinstated tactile profiles; removing the mould.

Optionally, the method further comprises, before removing the mould, allowing the liquid mix to cure.

Optionally, the method further comprises, before the liquid mix has cured, removing the mould.

Optionally, the tactile floor surface in the pre-worn form comprises one or more tactile profiles protruding from the floor surface, each tactile profile comprising: a first layer, and a second layer positioned over the first layer, wherein the first layer has a visibly distinguishable property such that, in use, when the second layer wears away, the visibly distinguishable property is revealed.

Optionally, the steps of: aligning the mould with the floor surface such that each worn tactile profile is located within a corresponding cavity of the mould; filling each cavity through an aperture with a liquid mix, the liquid mix configured to, when curing, adhere to the surface of the worn tactile profile thereby forming reinstated tactile profiles; and, removing the mould; are undertaken when the second layer has worn away such that the visibly distinguishable property is revealed.

Optionally, the step of filling each cavity substantially reinstates the second layer over the first layer.

Optionally, the liquid mix comprises a polymer either with or without an aggregate.

Optionally, the polymer comprises polyurethane.

Optionally, the aggregate comprises glass beads, aluminium oxide, or quartz individually or as a mix.

Optionally, the tactile floor surface is a tactile mat, a concrete paver, a ceramic, or a FRP/GRP tactile.

Optionally, each aperture is located at substantially the deepest part of each cavity.

Optionally, the method comprises an additional step of abrading each worn tactile profile before applying the mould to create a textured surface such that adhesion between the liquid mix and the worn tactile profiles is increased.

Optionally, a grinding tool or a sanding tool is used to perform the step of abrading each worn tactile profile.

Optionally, the method comprises an additional step of cleaning each worn tactile before applying the mould such that adhesion between the liquid mix and each worn tactile profile is increased.

Optionally, the cleaning is performed using a solvent such that substantially no residue is left on the worn tactile profiles such that adhesion between the liquid mix and the worn tactile profiles is increased.

Optionally, the step of filling each cavity through an aperture with the liquid mix is performed by directing the liquid mix though the aperture with an applicator tool.

In accordance with a fifth aspect of the invention there is provided a mould for reinstating one or more worn tactile profiles protruding from a tactile floor surface to a pre-worn form, the mould comprising: a plurality of cavities, each cavity shaped to correspond with a tactile profile in its pre-worn form, each cavity comprising an aperture through which a liquid mix can be transferred into the cavity.

Optionally, each aperture is located at substantially the deepest part of each cavity.

Optionally, the mould comprises an elastomer.

In accordance with a sixth aspect of the invention there is provided an apparatus for preparing and sheltering a substrate during a process in which tactile tiles are adhered to the substrate, the apparatus comprising: a cover for covering an area of the substrate to which tactile tiles are to be adhered; heating means configured to heat the area of the substrate to which tactile tiles are to be adhered to reduce the risk of delamination.

Optionally, the apparatus is mobile such that the apparatus can be moved along a path to which tactile tiles are to be adhered.

Optionally, the apparatus is mobile by virtue of castor wheels fitted to a base of the apparatus.

Optionally, the apparatus comprises: a heating section in which the heating means is located; an adhering section in which tactile tiles are adhered along the path.

Optionally, the heating means is configured to dry a first surface area of the path to which tactile tiles are to be adhered; and, the adhering section is dimensioned such that the available surface area to which tactile tiles can be adhered within the adhering section substantially corresponds with the first surface area.

Optionally, the heating section is positioned at a first end of the apparatus such that, when the apparatus is moved along the path with the first end located at the front of the apparatus with respect to direction of travel of the apparatus along the path, the heating means dries upcoming portions of the path to which tactile tiles are to be adhered.

Optionally, the apparatus further comprises a rolling means configured to apply pressure to tactile tiles that have been adhered to the substrate.

Optionally, the rolling means is positioned at a second end of the apparatus, the second end opposite the first end such that, when the apparatus is moved along the path, the rolling means applies pressure to tactile tiles that have been adhered to the path.

Optionally, the rolling means is positioned at least 4 meters behind the adhering section with respect to the direction of travel.

Optionally, the apparatus comprises a support structure to support the cover.

Optionally, the support structure is of sufficient mass to resist displacement due to wind forces of up to approximately 50 mph.

Optionally, the support structure comprises a rigid material such as wood, metal, fiberglass, or expanded foam.

Optionally, the support structure comprises metal which is resistant to rusting.

Optionally, the support structure comprises either galvanised steel or aluminium.

Optionally, the cover is secured to the support structure such that the cover is taut.

Optionally, the cover comprises an overhang running around the perimeter of the base of the apparatus, the overhang in contact with the substrate around the perimeter of the apparatus to inhibit water ingress onto the area of the substrate to which tactile tiles are to be adhered.

Optionally, the overhang is weighted.

Optionally, the overhang has a pocket formed therein, the pocket running substantially around the perimeter of the base of the apparatus and containing a weighted mass for weighting the overhang.

Optionally, the weighted mass is an aggregate such as sand.

Optionally, the weighted mass is a rod or chain made of metal, wood, or glass reinforced polymer.

Optionally, the heating means is provided by a gas heater wherein gas is burned to produce heat.

Optionally, the gas heater comprises a multi-head gas torch, the multi-head gas torch surrounded by an insulating box.

Optionally, the heating means is provided by an infrared heater.

Optionally, the apparatus further comprises a storage section to store adhesive and tactile tiles which are to be adhered to the substrate.

Optionally, the cover comprises plastic, rubber, or canvas.

Optionally, the apparatus further comprises a mixing means configured to mix adhesive that is used to adhere tactile tiles to the substrate.

Optionally, the mixing means is configured to mix the adhesive for a predetermined amount of time such that the adhesive fully cures and cross-links.

In accordance with a seventh aspect of the invention there is provided a method of installing tactile tiles using an apparatus in accordance with claim 1, the method comprising: heating the portions of the path to which tactile tiles are to be adhered; under the cover, adhering tactile tiles to the portions.

Optionally, the method comprises: moving the apparatus a predetermined distance along the path to which tactile tiles are to be adhered whilst heating the path to dry upcoming portions of the path to which tactile tiles are to be adhered; adhering tactile tiles to the dried portions.

Optionally, the method further comprises moving the apparatus at a predetermined rate such that the upcoming portions of the path to which tactile tiles are to be adhered is sufficiently dry to adhere tactile tiles thereto.

Optionally, the method further comprises: moving the apparatus a predetermined distance along the path wherein the distance corresponds to a length of an adhering section of the apparatus in which tactile tiles are adhered along the path, such that tactile tiles can be installed along the path along the length of the adhering section.

Optionally, the method further comprises: before adhering the tactile tiles to the path, stopping movement of the apparatus such that the apparatus is substantially stationary whilst the tactile tiles are being adhered to the path.

Optionally, the method further comprises: sequentially repeating the steps of: moving the apparatus a predetermined distance along the path to which tactile tiles are to be adhered whilst heating the path to dry upcoming portions of the path to which tactile tiles are to be adhered, and adhering tactile tiles to the dried portions, such that a continuous stretch of tactile tiles is produced.

Optionally, the method further comprises moving the apparatus along a guide, the guide configured to prevent lateral movement of the apparatus relative to the path.

The aim of the present invention is to overcome, or at least alleviate, where possible, the above mentioned disadvantages of the prior art and in particular to provide: an improved tactile floor surface (comprising one or more tactile profiles) which is able to be installed in inclement weather without the loss of adhesive performance; which is able to alert maintenance personnel or building owners when the tactile profiles have worn down to a predetermined level, which is undetectable underfoot; is able to be topped up in-situ to a detectable level; and is visible at night or in subdued lighting to both those with normal vision and those with impaired vision.

In accordance with certain aspects of the invention, a tactile floor surface, comprising one or more tactile profiles, is manufactured such that the one or more tactile profiles incorporate a first layer and a second layer. Where, the first layer protrudes from the floor surface by a predetermined amount (which corresponds to the lowest amount which is which is detectable underfoot under normal use). The second layer is positioned above the first layer. The first layer and second layer are differed colours and as such the first layer is visibly distinguishable from the second layer. In this way, when the second layer wears away (for example as a result of pedestrian foot traffic) it is clear that the one or more tactile profiles are at the threshold of detectability underfoot.

Advantageously, the change in of colour of the one or more tactile profiles alerts maintenance personnel to the fact that the tactile profiles have become worn to the threshold of detectability underfoot and as such have become dangerous to the visually impaired (because for the visually impaired underfoot detection may be their only means of detecting the tactile profiles).

In accordance with certain aspects of the invention, a method of reinstating worn tactile profiles is provided. The method comprises using a female mould which corresponds in shape to the pre-worn form of the tactile profiles to be reinstated, the mould comprising apertures through which a liquid top-up mix can be fed into the mould. The mould is aligned over the worn tactile profiles and a liquid top up mix is transferred into the mould such that the tactile profiles are topped up. Once cured, the tactile profiles are thereby reinstated.

Advantageously, reinstating the tactile profiles in this way, obviates the requirement to replace tactile surfaces when the tactile profiles wear to a level which is undetectable underfoot. This reduces waste and has a smaller carbon footprint relative to the process of replacing tactile surfaces. Further, the method can be carried out in-situ.

Advantageously, outer tactile profiles on tactile surfaces can be filled with glow in the dark polymer to warn both sighted and non-sighted pedestrians of the presence of a tactile surface, particularly in subdued lighting.

In accordance with certain embodiments of the invention, there is provided an apparatus for preparing and sheltering a floor surface to which tactile tiles are to be installed. The apparatus comprises a heating means configured to heat the area of the floor surface to which tactile tiles are to be adhered to reduce the risk of delamination and a cover for covering the area of the floor surface to which tactile tiles are to be adhered whilst tactile tiles are installed. Advantageously, by virtue of the apparatus, surface mounted tactile tiles can be installed on floor surfaces irrespective of inclement weather conditions.

### BRIEF DESCRIPTION OF DRAWINGS

Embodiments of the present invention will now be described by way of example only with reference to the accompanying drawings where like parts are provided with corresponding reference numerals and in which:

FIG. 1a provides a simplified schematic diagram of side profile of a blister tactile;

FIG. 1b provides a simplified schematic diagram of a side profile of a corduroy tactile;

FIG. 1c provides a simplified schematic diagram of a side profile of a guidance tactile;

FIG. 1d provides a simplified schematic diagram of a side profile of a cycle tactile;

FIG. 2 provides a simplifies schematic diagram of a side profile of a worn blister tactile;

FIG. 3 provides a simplified of a top surface of a silicone mould for a blister tactile;

FIG. 4 provides a simplified schematic diagram of top surface of a reinstated blister profile using ‘top up’ material;

FIG. 5a provides a simplified schematic diagram of a plan view of a blister tactile illustrating blisters filled with glow;

FIG. 5b provides a simplified schematic diagram of a side profile of a blister tactile for crossings;

FIG. 5c provides a simplified schematic diagram of a plan view of a blister tactile for a platform edge (off-street);

FIG. 5d provides a simplified schematic diagram of a side profile of a blister tactile for a platform edge (off-street);

FIG. 5e provides a simplified schematic diagram of a plan view of a corduroy tactile;

FIG. 5f provides a simplified schematic diagram of a side profile of a corduroy tactile;

FIG. 5g provides a simplified schematic diagram of a plan view of a guidance tactile;

FIG. 5h provides a simplified schematic diagram of a side profile of a guidance tactile;

FIG. 5i provides a simplified schematic diagram of a plan view of a cycle tactile;

FIG. 5j provides a simplified schematic diagram of a side profile of a cycle tactile;

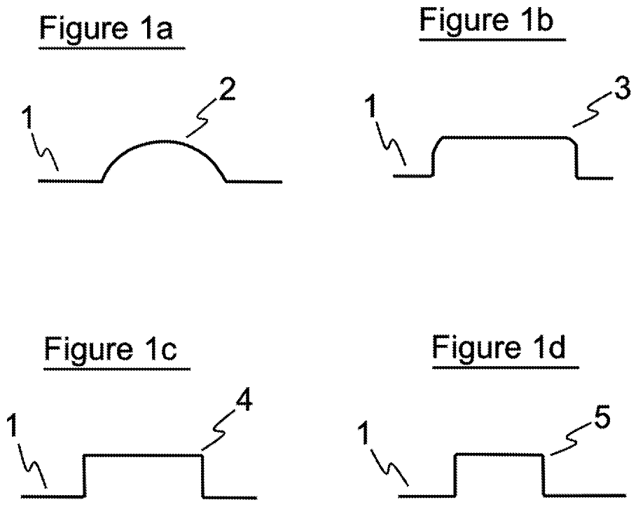

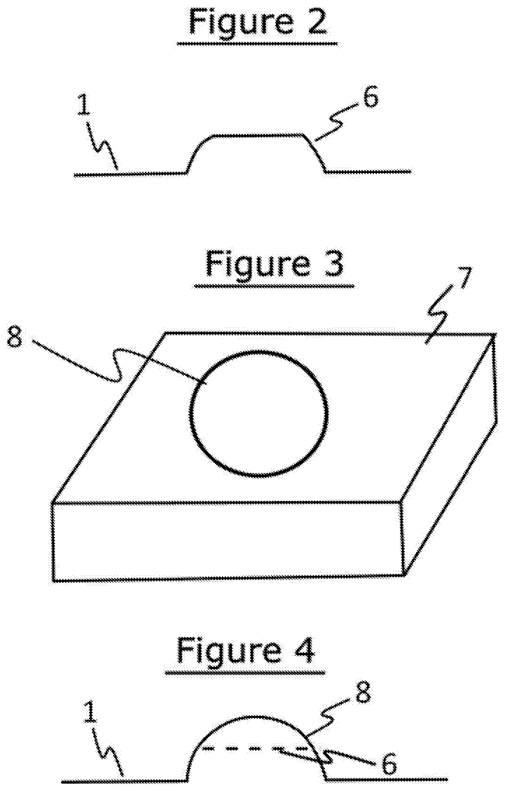

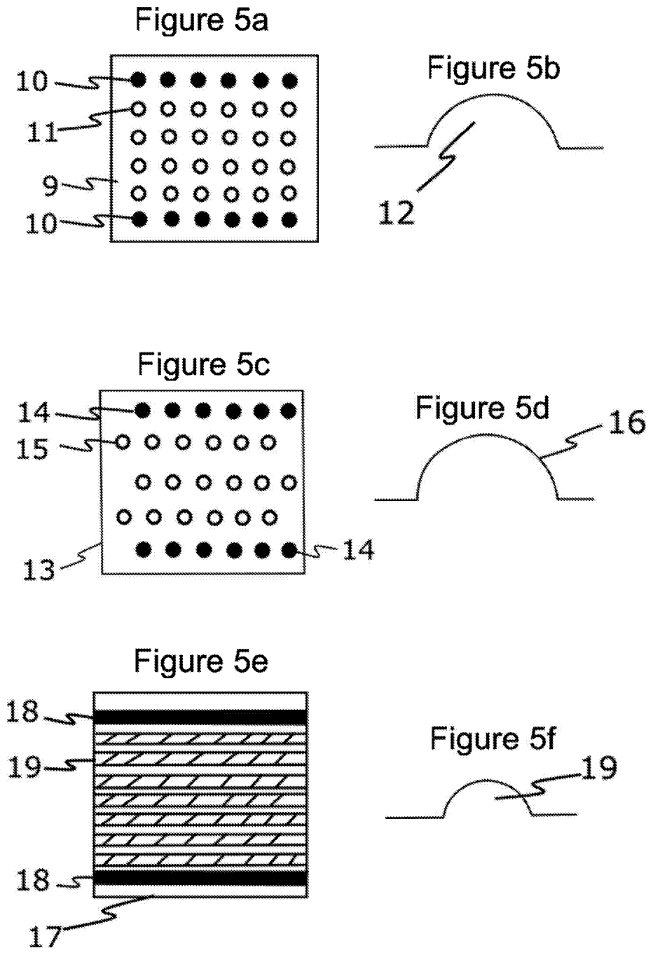

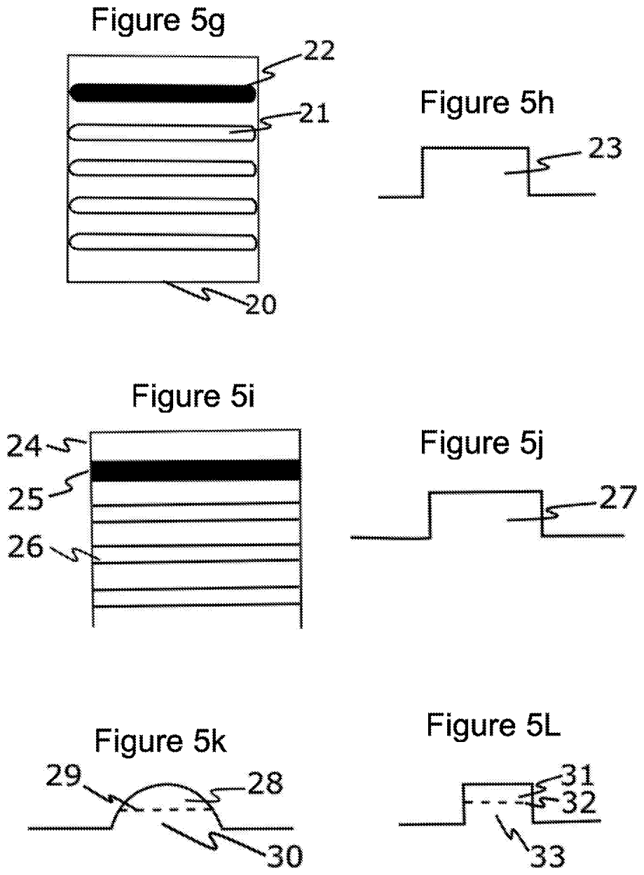

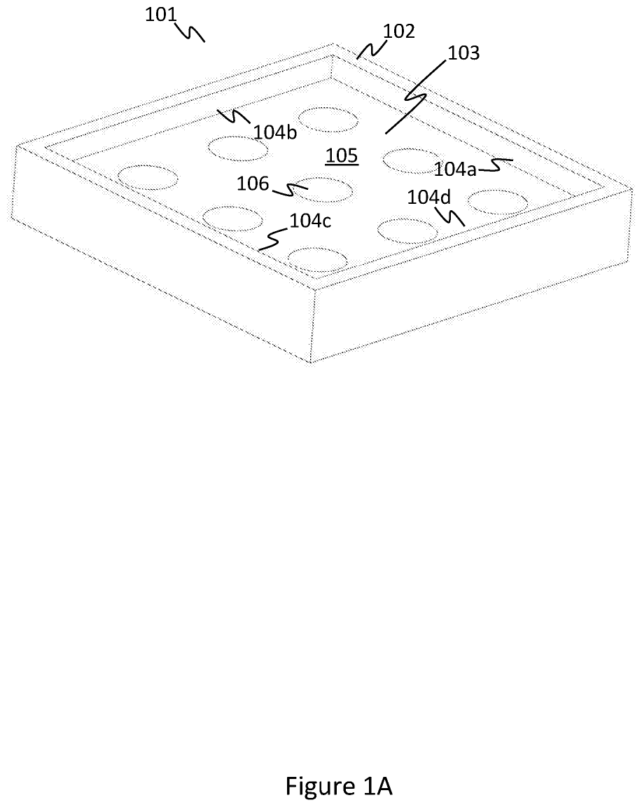

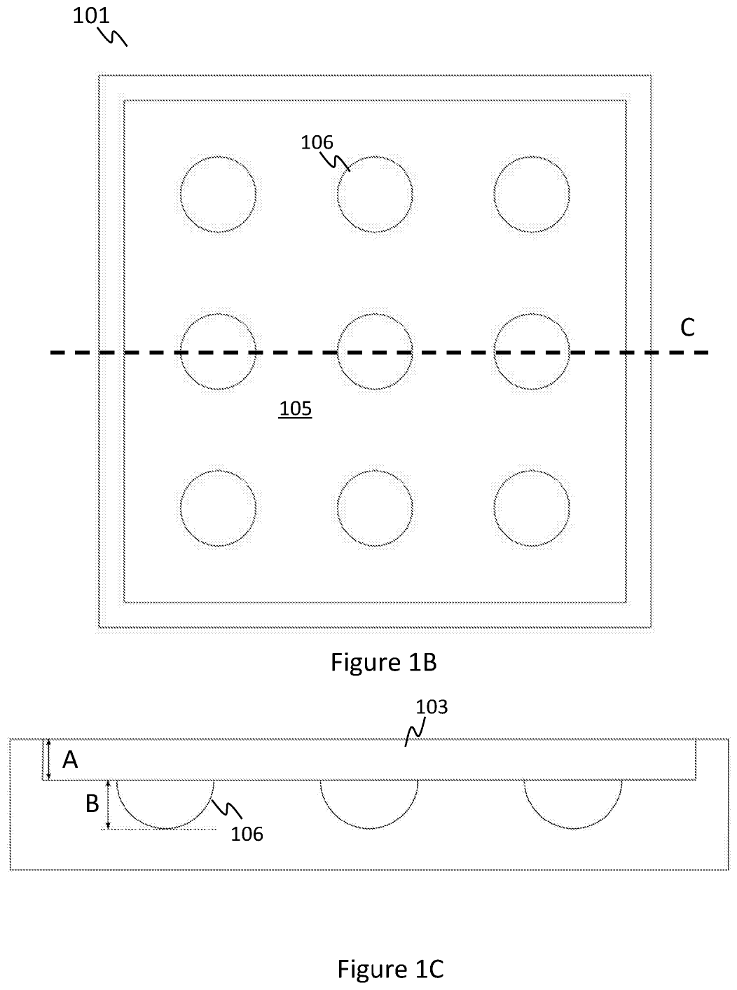

FIG. 1A provides a simplified schematic diagram of an open topped mould for manufacturing a tactile tile comprising a tactile alert system in accordance with certain embodiments of the invention;

FIG. 1B provides a simplified schematic diagram of a top view of the mould shown in FIG. 1A;

FIG. 1C provides a simplified schematic diagram of a cross sectional view of the mould shown in FIG. 1A;

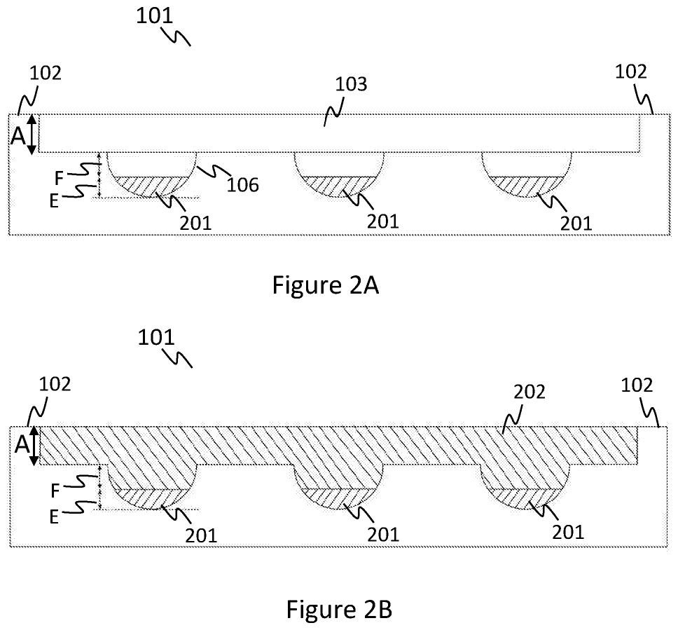

FIG. 2A provides a simplified schematic diagram depicting the addition of a first polymer and aggregate mixture, of a first colour, to the mould shown in FIG. 1A;

FIG. 2B provides a simplified schematic diagram depicting the addition of a second polymer and aggregate mixture, of a second colour, to the mould shown in FIG. 1A;

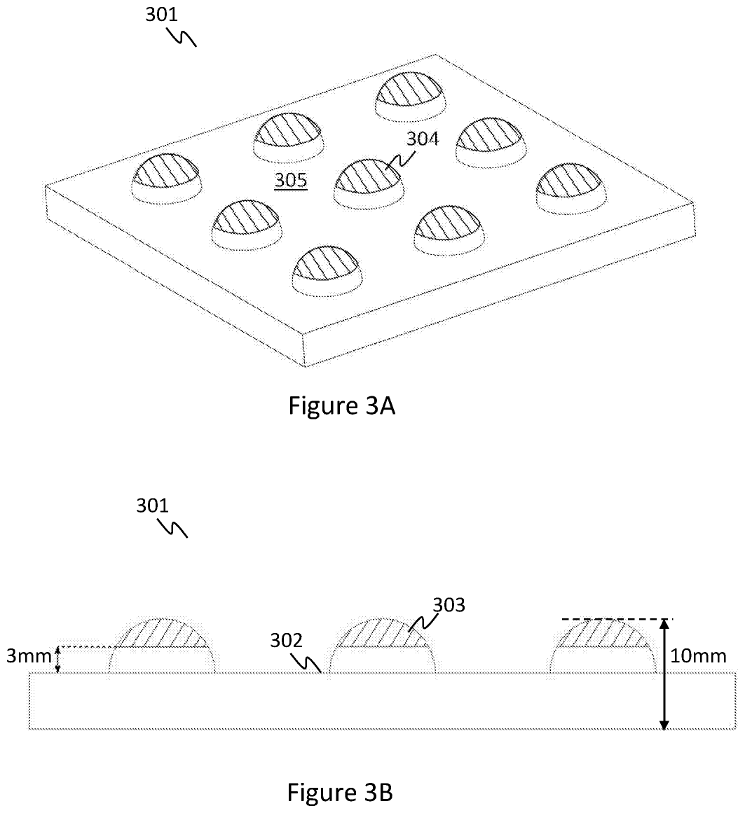

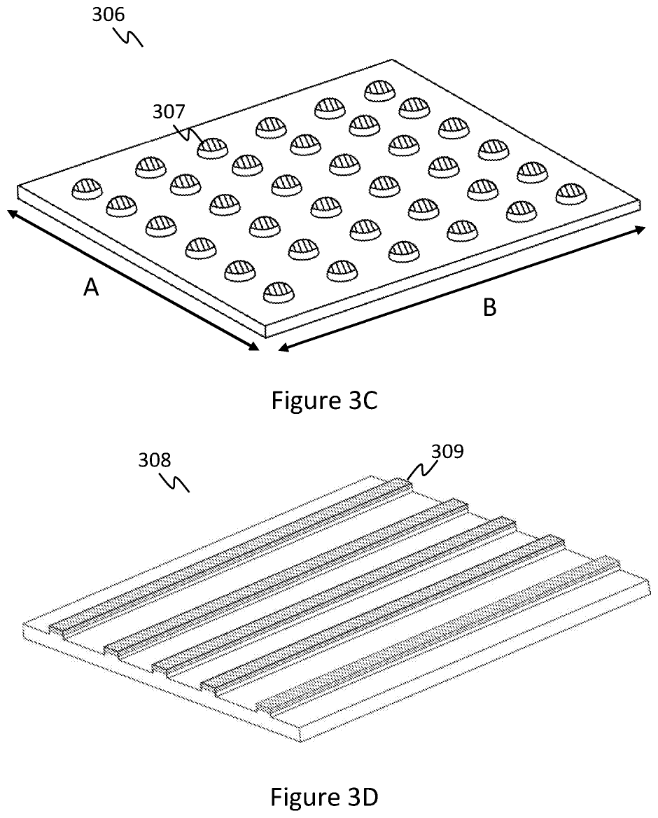

FIG. 3A provides a simplified schematic diagram of a tactile tile formed in accordance with the process described with reference to FIGS. 1A to 2B;

FIG. 3B provides a simplified schematic diagram of a side view of the tactile tile shown in FIG. 3A;

FIG. 3C provides a simplified schematic diagram of a tactile tile formed in accordance with certain embodiments of the invention;

FIG. 3D provides a simplified schematic diagram of a tactile tile formed in accordance with certain embodiments of the invention comprising linear tactile profiles;

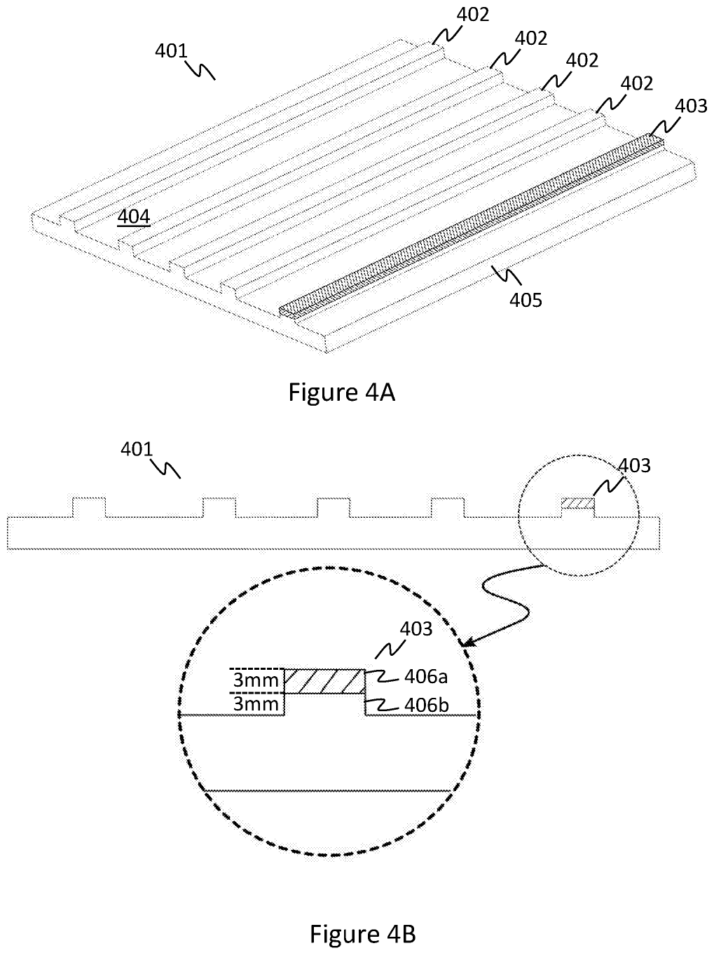

FIG. 4A provides a simplified schematic diagram of a tactile tile manufactured in accordance with certain embodiments of the invention;

FIG. 4B provides a simplified schematic diagram of a side profile of the tactile tile shown in FIG. 4A;

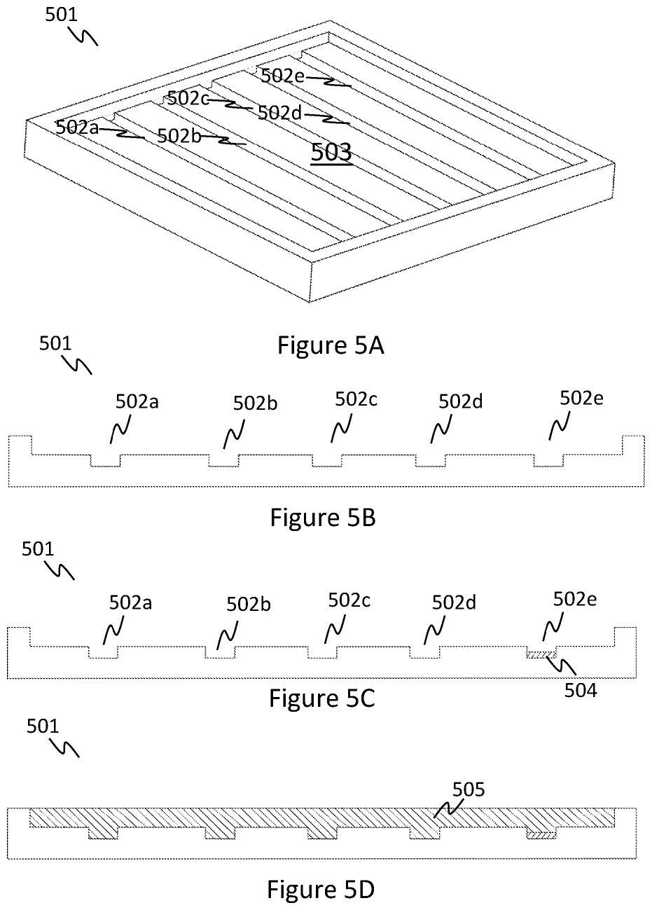

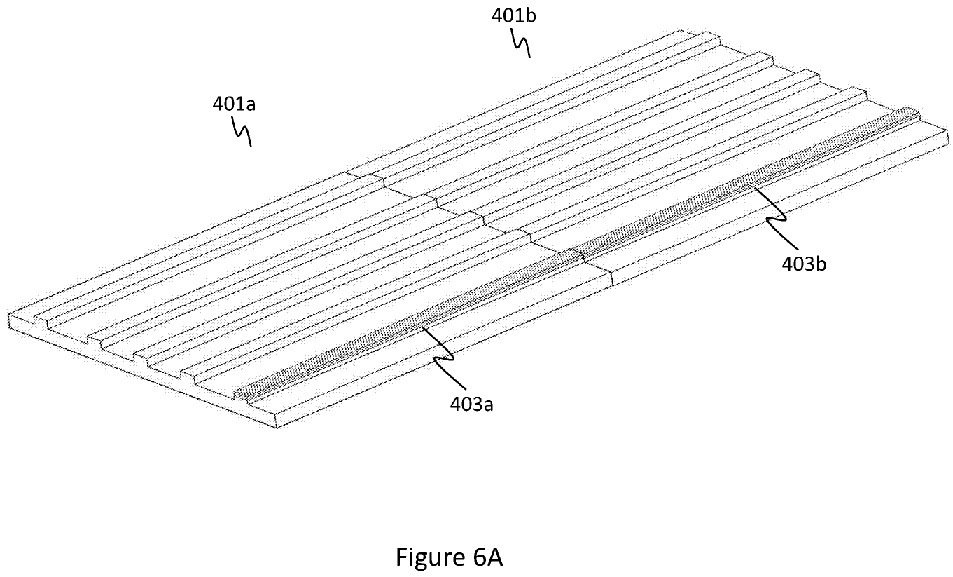

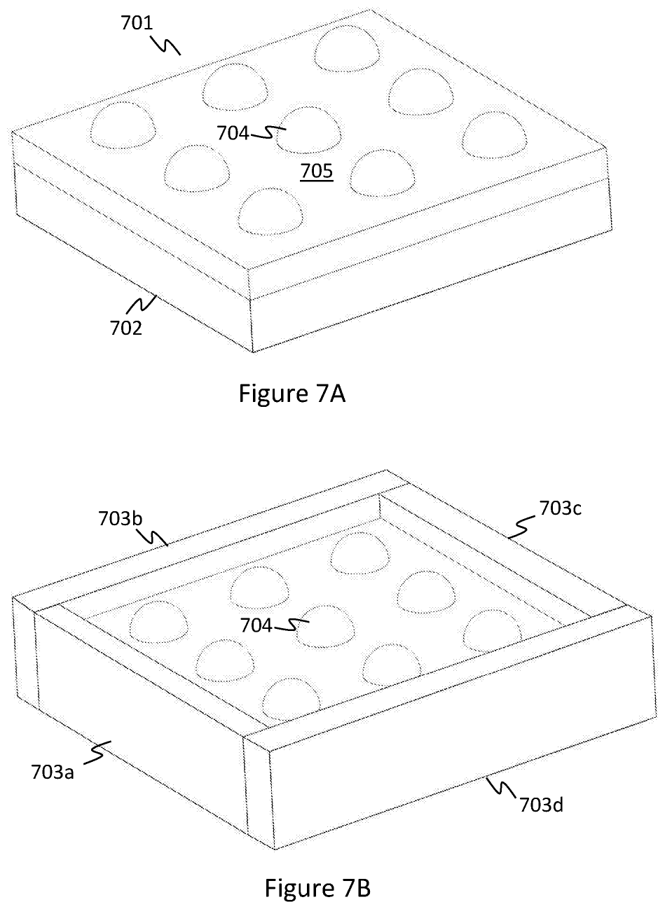

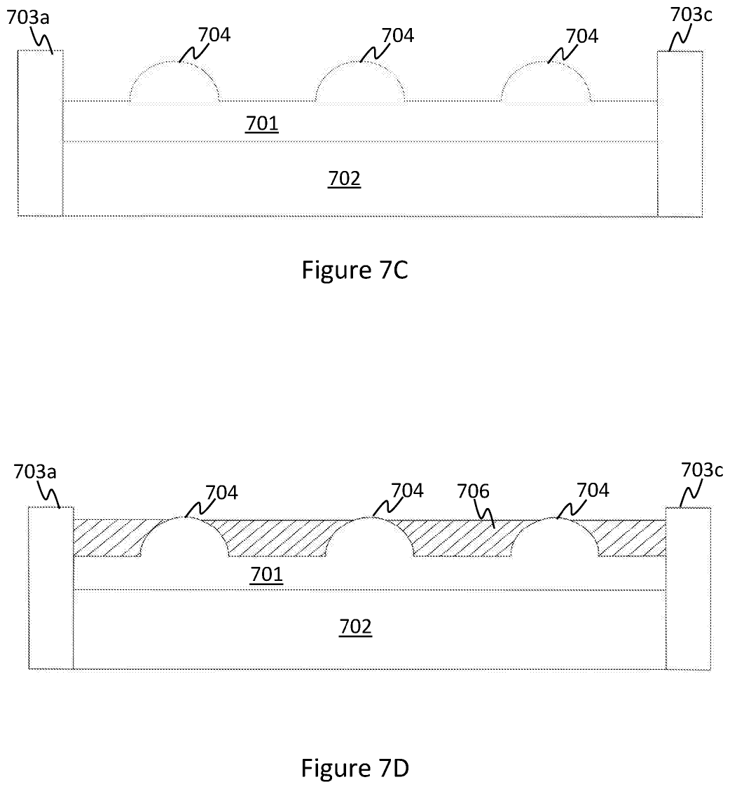

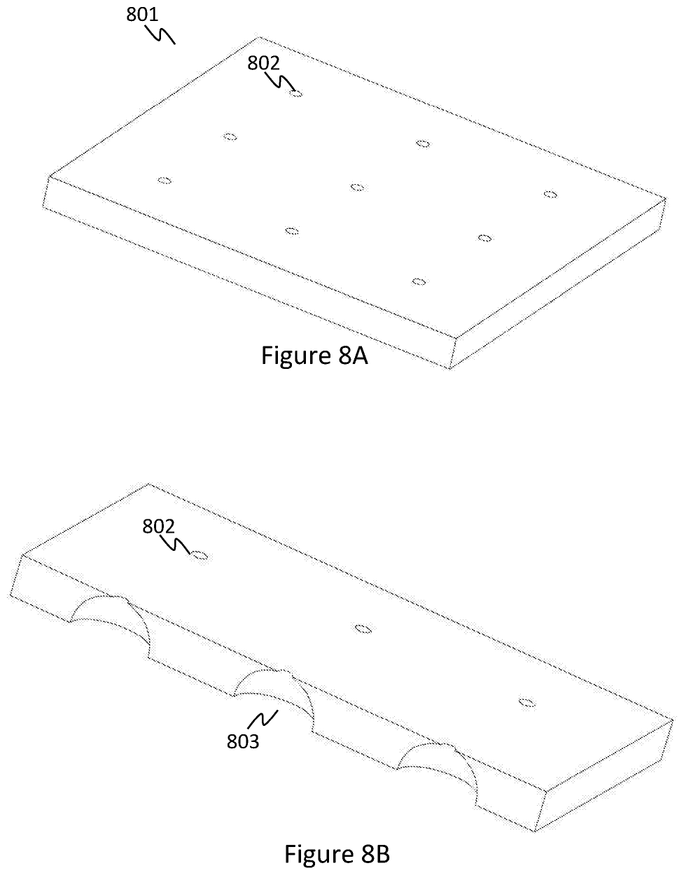

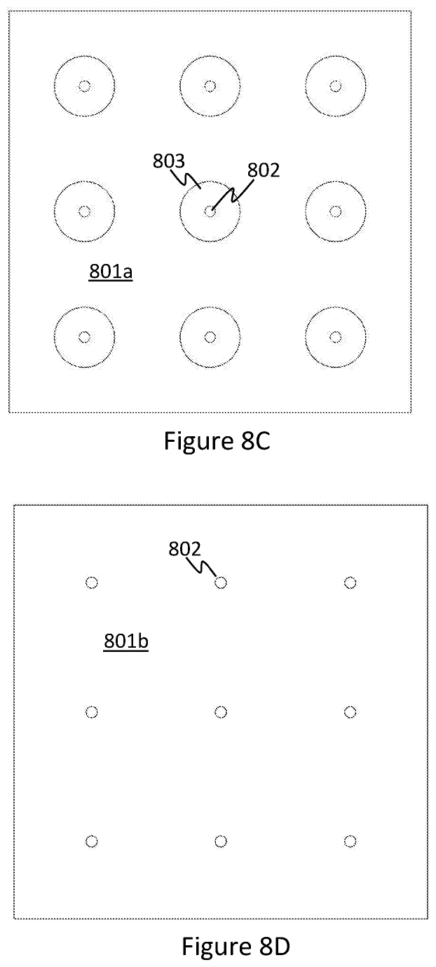

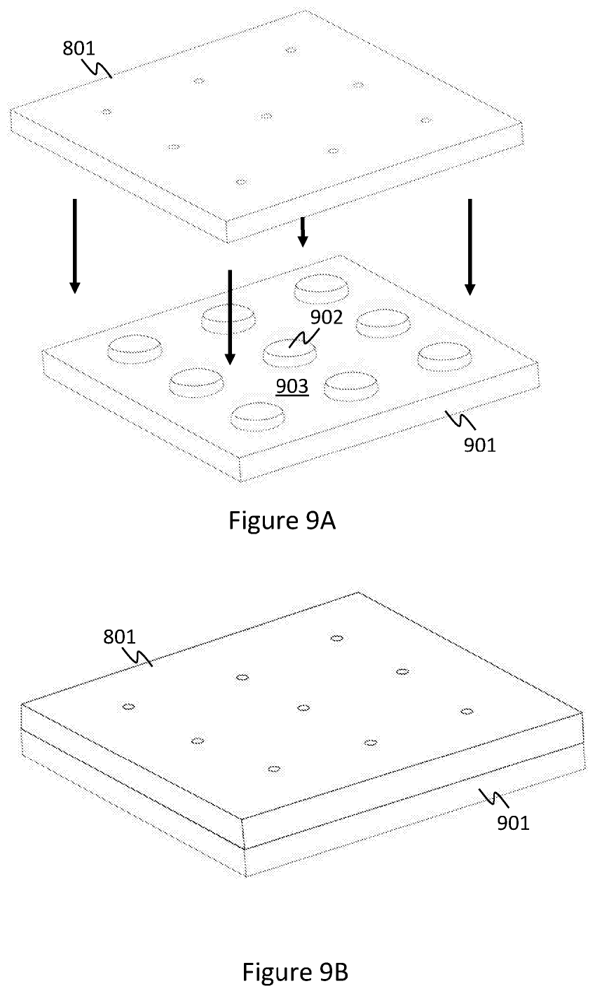

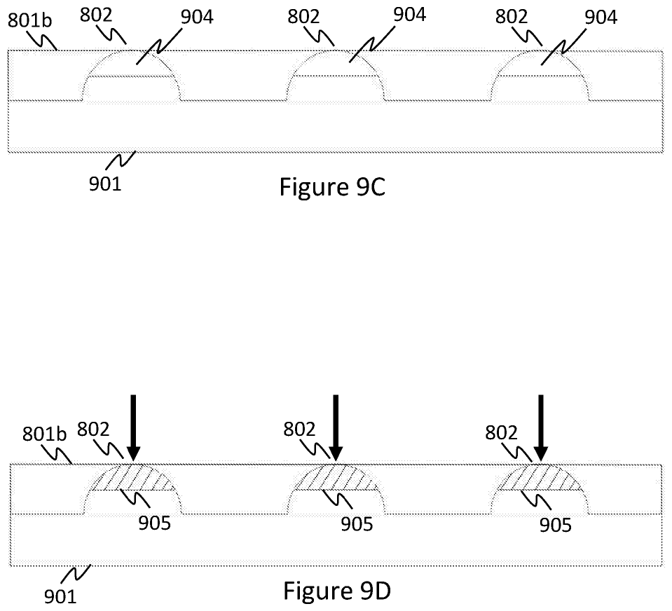

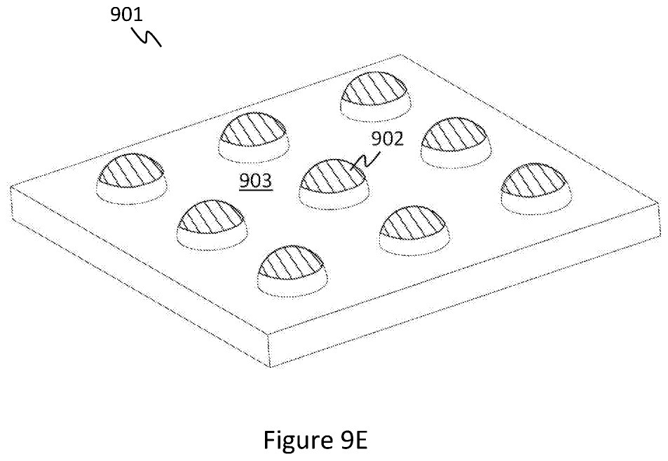

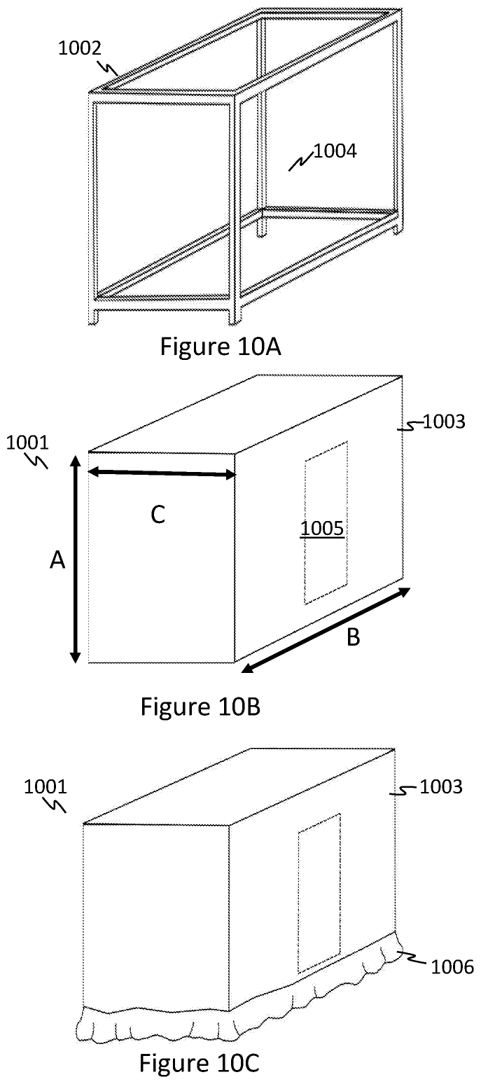

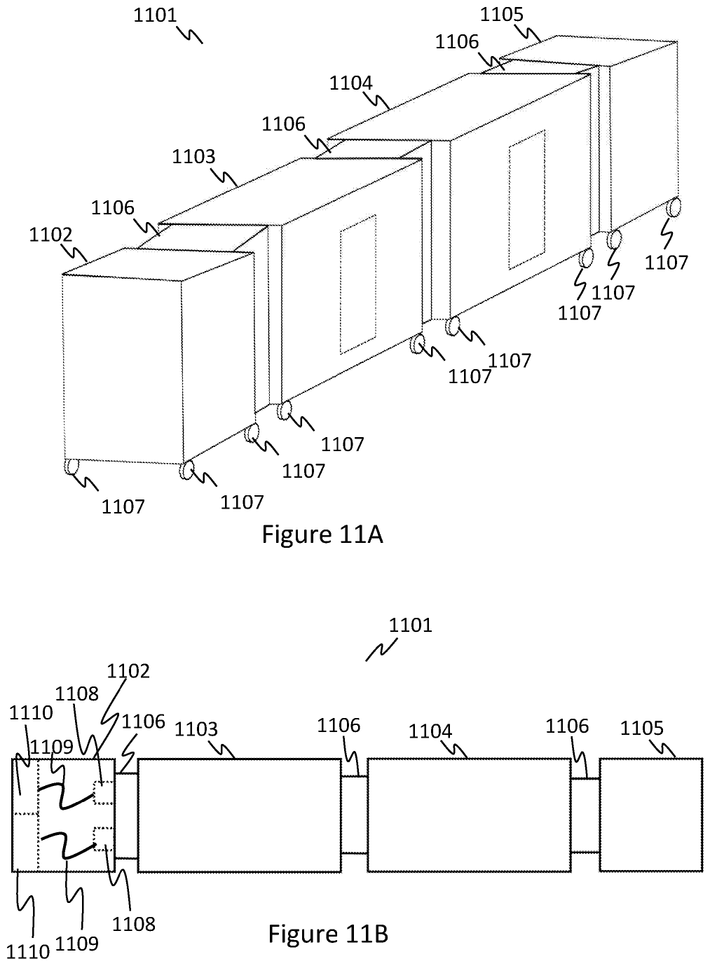

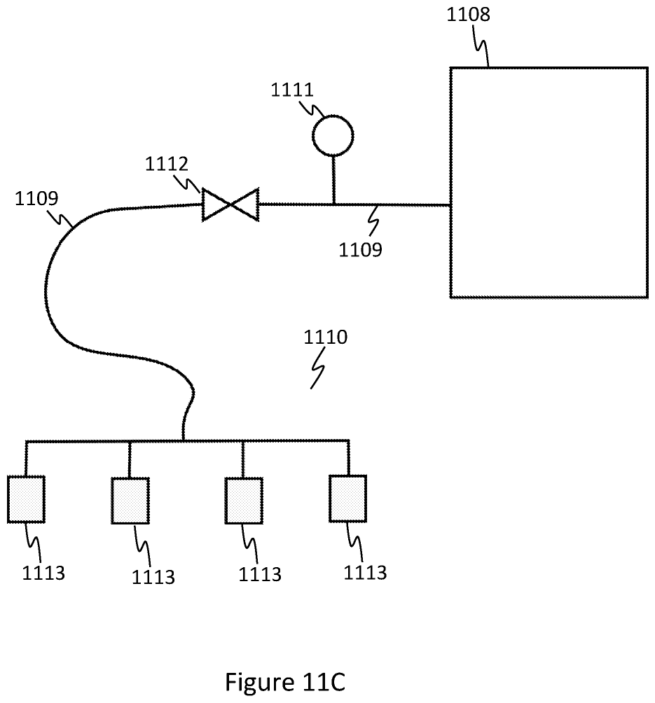

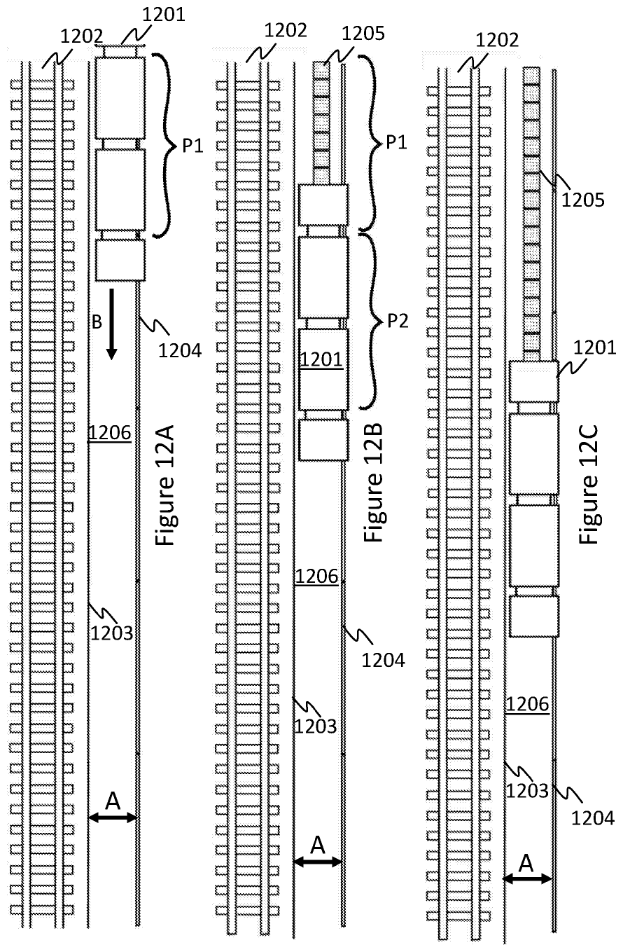

FIG. 5A provides a simplified schematic diagram of an open topped mould for manufacturing the tactile tile shown in FIG. 4A;

FIG. 5B provides a simplified schematic diagram of a cross section of the open topped mould shown in FIG. 5A;

FIG. 5C provides a simplified schematic diagram depicting the addition of a glow-in-the-dark mixture to a single channel of a chamber of the open topped mould shown in FIG. 5A;

FIG. 5D provides a simplified schematic diagram depicting the addition of a non-glow-in-the-dark mixture to the chamber shown in FIG. 5C until it is filled.

FIG. 6A provides a simplified schematic diagram showing two tactile tiles (each of which correspond with the tactile tile described with reference to FIGS. 4A and 4B) positioned adjacent one another.

FIG. 7A provides a simplified schematic diagram depicting a first step in forming a female mould;

FIG. 7B provides a simplified schematic diagram depicting a subsequent step in forming a female mould;

FIG. 7C provides a simplified schematic diagram depicting a cross section view of a subsequent step in forming a female mould;

FIG. 7D provides a simplified schematic diagram depicting a cross section of a subsequent step in forming the female mould.

FIG. 8A provides a simplified schematic diagram of a female mould resulting from the moulding process described with reference to FIGS. 7A to 7D;

FIG. 8B provides a simplified schematic diagram of a central cross-sectional view of the female mould shown in FIG. 8A;

FIG. 8C provides a simplified schematic diagram of a top view of a first side of the female mould shown in FIG. 8A;

FIG. 8D provides a simplified schematic diagram of a top view of a second side of the female mould shown in FIG. 8A.

FIG. 9A provides a simplified schematic diagram depicting application of the female mould shown in FIG. 8A to a worn tactile tile;

FIG. 9B provides a simplified schematic diagram showing the female mould shown in FIG. 8A when applied to the worn tactile tile shown in FIG. 9A;

FIG. 9C provides a simplified schematic diagram showing a central cross-sectional view of the arrangement shown in FIG. 9B before a top-up mix has been applied;

FIG. 9D provides a simplified schematic diagram showing the central cross-sectional view shown in FIG. 9C when a top-up mix has been applied;

FIG. 9E provides a simplifies schematic diagram of a ‘topped up’ tactile tile.

FIG. 10A provides a simplified schematic diagram of a three-dimensional structure for supporting a shelter system arranged in accordance with certain embodiments of the invention;

FIG. 10B provides a simplified schematic diagram of a shelter system arranged in accordance with certain embodiments of the invention;

FIG. 10C provides a simplified schematic diagram of a shelter system with a pocket positioned around the perimeter of its base.

FIG. 11A provides simplified schematic diagram of a shelter system arranged in accordance with certain embodiments of the invention;

FIG. 11B provides a simplified schematic diagram of a top view of the shelter system shown in FIG. 11A;

FIG. 11C provides a simplified schematic diagram of certain components of a heating system housed within the shelter system shown in FIG. 11A;

FIG. 12A provides a simplified schematic diagram of a shelter system in a first position on a railway platform;

FIG. 12B provides a simplified schematic diagram of the shelter system shown in FIG. 12A in a second position on the railway platform, and

FIG. 12B provides a simplified schematic diagram of the shelter system shown in FIG. 12A in a subsequent position on the railway platform.

### DETAILED DESCRIPTION

The present invention relates to improved safety features for tactile paving.

A top up system, applied in-situ to worn tactile profiles, (which are used to convey information to the blind/visually impaired) which have become undetectable underfoot to the visually impaired, enables the filling of tactile profiles and hence the detection underfoot by the visually impaired. Outer tactile profiles on tactile surfaces can be filled with glow in the dark polymer to warn both sighted and non-sighted pedestrians of the presence of a tactile surface, particularly in subdued lighting.

Where service providers of tactile surfaces require to know when tactile profiles are below the detectable height then the tactile profiles can be filled with a coloured resin/aggregate mix above the 3 mm detectable threshold with the remaining tactile tile filled with a resin/aggregate mix of a contrasting colour.

In accordance with first aspect of the present invention there is provided a tactile tile, either corduroy, blister, guidance or cycle tactile, normally 400 mm or 450 mm square, fabricated from either concrete, rubber or plastic with all the tactile profiles in-tact to a standard height of 5.5 mm minimum-6 mm maximum.

The tactile tile is adhered onto a base fabricated to the same dimensions as the tactile tile. The base can be manufactured from wood, metal, plastic, glass, or preferably from any impervious material. Where the material is porous the material is sealed with a suitable sealant and allowed sufficient time to cure. Side panels are attached to the base plate to the height of the tactile profile to create an open topped ‘bund’. They are also sealed and left to dry.

Release agent is applied over the surface area of the tactile profile and allowed sufficient time to dry. A suitable material which is used to make moulds, is poured into the open topped bund, and filled to the top of the tactile tile such that the highest part of the tactile profiles are left uncovered. Preferably the mould material is silicone. The silicone is allowed to cure/dry and is subsequently removed from the tactile tile. The silicone shape removed forms a 3 dimensional stencil of the tactile tile.

The silicone mould can then be applied to any ‘worn tactile surface’ of similar dimensions, in-situ placing the mould directly on top of the worn tactile such that the tactile profiles and the recesses of the mould are directly lined up.

To maximise adhesion, the worn tactile is mechanically prepared, by using a sander, grinder or other suitable abrading device, to create a textured surface to maximise adhesion between the tactile profile and the ‘top up’ material. Dust can be removed using a vacuum device. Residual dust/dirt is removed from the tactile profile surface using a suitable cleaner/detergent/solvent. Preferably a solvent is used as no residue is left on the tactile profile surface.

A top up material is applied over the top surface of the silicone mould and allowed to flow into the tactile profile recesses which have worn away.

The preferred top up material is a resin, such as a thermoplastic or thermoset resin, polyurethane, epoxy, acrylic or polyester. Preferably epoxy or polyurethane is used as the top up material.

Aggregate is mixed in with the top up material to provide for anti-slip and improved wear properties. The preferred aggregates include quartz, flint, carborundum, aluminium oxide, or glass. More preferably quartz is used as the aggregate.

To prevent the top up material leaking from the tactile profile recesses the top up material can be thickened using a suitable thickening agent such as calcium carbonate, silica or other suitable materials. Preferably silica is used to thicken up the top up material.

The silicone mould can be removed once the top up material has been applied either pre or post curing, to leave the tactile tile with fully reinstated tactile profiles.

Preferred embodiments of the first aspect of the present invention will now be described, by way of example only and not in any limitative sense, with reference to the accompanying drawings.

An example of the top up system used to replenish worn tactile profiles to their original height is described below.

It is imperative that blister tactiles for rail platforms are maintained to a height of above 3 mm so that the visually impaired are warned of the location of a platform edge. Where tactile profiles have been worn down below 3 mm then the top up system can be used to re-instate the height of the blister profiles.

FIG. 2 illustrates a worn blister tactile, 6 on a rail platform, 1. A grinder is used to grind off the top surface of the blister profile to create a textured surface to maximise adhesion with the top up material. The dust is removed using a vacuum system and is further cleaned using a solvent wipe to remove any residual dust/grease/dirt.

FIG. 3 illustrates a silicone mould, 7 with a circular recess, 8 which matches the dimensions of a blister profile without wear, 8. The silicone mould is placed directly above the worn blister profile, 6 and a resin/aggregate mix is placed onto the top of the silicone mould, 7. The resin/aggregate mix is moved across the top of the circular recess, 8 and allowed to flow into the recess and onto the worn profile, 6 until the void, 8 is completely filled with the resin/aggregate mix. The top surface is then smoothed with a flat applicator and the silicone mould can then be removed, leaving a replenished blister profile, back to its original height of 5.5 mm. This is then allowed to fully cure and the platform can be opened up to traffic.

In accordance with a second aspect of the present invention there is provided a solution for normal sighted and non-sighted people to help identify the edge of a tactile surface in order to prevent trip accidents and provide navigational assistance. The outer tactile profiles are filled with a polymer containing a phosphorescent pigment, (glow polymer), which in subdued lighting illuminates so that the edge of the tactile surface can be identified reducing trips and also providing navigational assistance to both sighted and non-sighted pedestrians.

Tactile surfaces which benefit from this are blister tactiles for crossings and platform edges (off-street), corduroy tactiles used to warn for a change of height, cycle tactiles used to warn for the presence of cyclists and guidance tactiles used to guide the visually impaired around hazards.

The glow in the dark tactile profiles are manufactured by filling the outer tactile profiles with a glow polymer in an open topped mould which replicates the tactile tile dimensionally.

The glow polymer can be any resin, acrylic, polyurethane, epoxy, thermoplastic or polyester. Preferably the resin is an Ultra-violet resistant Polyurethane. Glow pigment is dispersed in the UV resistant polyurethane by mixing manually or through a mixing machine to produce the glow polymer. The glow polymer is then poured into the outer tactile profiles within the open topped mould until they are completely full to the base of the tactile. Once the outer tactiles profiles have been filled with glow polymer, then the remaining polyurethane of any specific colour can be poured into the open topped mould, pre or post curing of the glow polymer, to a height which is equivalent to the height of the tactile tile. Once all elements of the tactile have cured then the complete tile can be removed from the mould.

Preferred embodiments of the second aspect of the present invention will now be described, by way of example only and not in any limitative sense, with reference to the accompanying drawings.

On a railway platform blister tactiles are installed to warn the visually impaired of the railway platform edge. A line of tiles, 13 are positioned adjacent to one another to form a line which runs the full length of the platform. Outer blisters, 14 are filled with glow in the dark polymer which fills the entire blister, 16. This then alerts both sighted and non-sighted people to the presence of the tactile surface, both day and night helping prevent trip accidents particularly in subdued lighting.

A further example is for when the visually impaired are guided around hazards using guidance tactiles, 20. Two rows of guidance tactiles, 20 placed adjacent to one another navigate the visually impaired around the hazard, such as pedestrian pavement which has been dug up. Only one bar of the outer guidance tactile, 22 is filled with glow polymer such that when 2 guidance tiles are joined together it creates a pathway. This is beneficial to both sighted and non-sighted people in subdued lighting as it creates an illuminated pathway around the hazard which aids navigation.

A further example is used for cyclists as a navigational tool.

The glow in the dark polymer is filled into the outer bar, 25 of the cycle tactile, completely filling the bar to the depth of the tactile profile, 27.

For a segregated pathway cycle tactiles are used to position the visually impaired to walk on one side of the pathway. The cycle tiles are positioned at right angles to the direction of pedestrian travel whereas the cycle tiles are positioned in the direction of travel for the cyclists. Six tiles, with the outer bars filled with glow polymer, are placed in a line adjacent to one another, in the outer and inner row, with the remaining cycle tiles, with outer bars filled with no glow polymer, placed in between the inner and outer rows.

This then creates a pathway for cyclists to travel along which is beneficial in subdued lighting conditions for both the cyclist and the visually impaired.

A third aspect of the invention is to highlight the detectable and undetectable levels by use of a change in colour contrast.

For example in FIG. 5k, a blister profile, 28 can be filled in an open topped mould with a glow polymer until it reached the cut-off point, 29 at a height of 3 mm where below this height the tactile profile becomes undetectable to the visually impaired. The remaining section of the blister profile, and indeed the complete tactile tile can be filled with a resin/aggregate mix which is of different colour to the glow polymer, pre or post curing of the glow polymer.

On curing the tactile can be removed from the mould.

This would enable any service provider, such as councils and railway service providers to inspect their tactile surfaces and once tactile profiles change colour, i.e., the tactile profiles have been worn away below the 3 mm detectable height cut off, then the provider would know to top up the profile to the detectable level.

The present disclosure also includes the following numbered clauses.
1. In the first aspect of the invention a top up system which is able to fill tactile profiles which have worn and are undetectable to the visually impaired to a level where they are detectable underfoot.
2. The tactile profiles are filled using a 3-dimensional stencil tile which replicates an ‘as new’ tactile tile with apertures at the top of the stencil in order to fill the voids formed due to pedestrian wear.
3. A 3-dimensional stencil tile can be used to fill worn blister tactiles for crossings, blister tactiles used to highlight the edge of a railway platform (off-street), corduroy tactiles to highlight a change in height, cycle tactiles and guidance tactiles to guide around hazards.
4. The 3-dimensional stencil tile can be made from any material used to manufacture moulds.
5. Preferably, the 3-dimensional stencil is made from silicone.
6. Preferably the worn tactile profiles are abraded prior to the top up procedure.
7. Preferably the abrading tool used is either a sander or a grinding tool.
8. Preferably the worn tactile profiles are cleaned prior to the top up procedure.
9. Preferably the cleaner used is a solvent as it leaves no residue.
10. The 3-dimensional stencil tile is placed directly over the worn tactile tile and a top up mix is placed on top of the 3-dimensional stencil tile.
11. The top up mix can is preferably a resin/aggregate mix.
12. The resin can either be a thermoplastic or a thermoset resin.
13. Preferably the resin is a polyurethane or epoxy resin.
14. The preferred aggregates include quartz, flint, carborundum, aluminium oxide, or glass.
15. More preferably the aggregate used is quartz.
16. The top up mix is moved across the 3-dimensional stencil tile using an applicator to divert the material into tactile profile voids.
17. The applicator can be made from wood, plastic or metal in the form of a standard scraping tool.
18. The 3-dimensional stencil tile can be removed pre or post cure from tactile tile and sufficient time is allowed for the tactile cure top up to cure before acceptance of pedestrian traffic.
19. In the second aspect of the invention the outer tactile profiles of a tactile tile are filled with a glow in the dark pigment/polymer mix (glow polymer) during the manufacturing phase.
20. Preferably the manufacturing phase consists of an open topped mould which matches the tactile tile dimensionally where resin/aggregate can be poured into it and allowed to cure.
21. Preferably the polymer is ultraviolet resistant and transparent to maximise glow in the dark properties.
22. The glow in the dark pigment is mixed with the polymer using manual or automatic mixing and then poured into the tactile profile completely filling the tactile profile.
23. The remaining resin/aggregate used to manufacture the tactile tiles can then be added on top of the glow polymer profiles to completely fill the whole tactile tile, pre or post curing of the glow polymer.
24. Once cured the tactile tile can be removed from the mould.
25. The glow in the dark profiles can be used to mark the edge of blister tactiles on crossings or railway platforms.
26. The glow in the dark profiles can be used to highlight the edge of guidance tactiles creating pathways for navigation assistance for sighted and non-sighted pedestrians.
27. The glow in the dark profiles can be used to highlight cycle routes on segregated pathways.
28. A third aspect of the invention is to manufacture a tactile tile that indicates a colour change between whether a tactile profile is detectable or undetectable, 3 mm height.
29. The preferred manufacturing process is by using an open topped mould whereby the tactile profiles are filled to a vertical height using a polymer/aggregate mix with a specific colour, and the remaining tactile can then be filled with a polymer/aggregate mix of a contrasting colour.
30. As in statement 29, where a glow polymer is used to fill the tactile profiles from 5.5 mm to the 3 mm cut off and a polymer/aggregate mix with a contrasting colour is used to fill the rest of the tactile tile.

In addition to the above description, a more detailed description of certain embodiments of the invention, now follows.

### Tactile Alert System

In accordance with certain aspects of the present invention there is provided a manufacturing process for manufacturing a ‘tactile alert’ system configured to provide a visual means of detecting wear of tactile profiles.

The tactile alert system is a tactile floor surface comprising one or more tactile profiles which are arranged to protrude from the floor surface (for example, as a means of warning visually impaired people that they are approaching hazards, as described above). Each of the one or more tactile profiles comprises a first layer and a second layer which are visibly distinguishable from each other (by virtue of being different colours). The second layer is positioned over the first layer such that when the second layer is worn away, the first layer becomes visible.

In this way, the colour of the one or more tactile profiles varies with respect to their height, such that, a visible change in colour of a tactile profile indicates that the tactile profile has been worn down below a height of 3 mm. That is, each tactile profile has lower portion (the first layer) which protrudes from the floor surface by 3 mm formed in a first colour and an upper portion, (the second layer) formed in a different colour, located on top of the lower portion and taking the total tactile profile height to an upper range between 5.5 mm and 6 mm. The first portion is configured to protrude from the floor surface by 3 mm because this corresponds to the amount that such tactile profiles must protrude to be detectable underfoot. The tactile profiles of the tactile alert system can be integrally formed as part of a tactile tile.

FIG. 1A provides a simplified schematic diagram of an open topped mould 101 for manufacturing a tactile tile comprising a tactile alert system in accordance with certain embodiments of the invention. FIG. 1B provides a simplified schematic diagram of a top view of the mould 101. FIG. 1C provides a simplified schematic diagram of a cross sectional view of the mould 101.

The mould 101 comprises a first surface 102, walls 104a 104b 104c 104d, a second surface 105. The second surface 105 has nine substantially identical hemispherical recesses 106 (or cavities) recessed therein. It is within these recesses that the tactile profiles will be formed, so, the recesses 106 substantially correspond in shape to the tactile profiles of the resulting tactile alert system.

FIG. 1C is a cross sectional view of the mould 101 along line ‘C’ (shown in FIG. 1B) in which the height ‘A’ of the walls 104a 104b 104c 104d and the depth ‘B’ of the recesses 106 can be seen. Typically ‘A’ is approximately 4 mm and ‘B’ is between the range of 5.5 mm to 6 mm.

The volume bounded by the second surface 105 and walls 104a 104b 104c 104d (up to the level of the surface 102) forms a chamber 103 within which a liquid polymer and aggregate mixture can be poured or injected to form a tactile tile. The process of filling the mould chamber 103 to form a tactile tile is described with reference to FIGS. 2A and 2B, as follows.

FIG. 2A provides a simplified schematic diagram depicting the addition of a first liquid polymer and aggregate mixture 201, of a first colour, to the mould 101. FIG. 2B provides a simplified schematic diagram depicting the addition of a second liquid polymer and aggregate mixture 202, of a second colour, to the mould 101.

In a first step, a release agent is applied (for example, by spraying or brushing) to the surfaces of the chamber 103 (the surface 105, recesses 106, and walls 104a 104b 104c 104d) to prevent the polymer and aggregate mixes from which the resulting tactile tile will be formed from sticking to the chamber 103 such that it can be released in a single piece.

The release agent can be any silicone-based system. Preferably a silicone oil/petroleum distillate mix is brushed onto the surface of the open topped mould and allowed sufficient time for the petroleum distillate to evaporate off.

In a second step, the first polymer and aggregate mixture 201 is mixed. The first polymer and aggregate mixture 201 is coloured with a first colour. The mixture comprises a pre-mixed two-part polyurethane liquid (the polymer), and combination of quartz and/or glass beads. Typically the ration between polyurethane and aggregate is 50% but this can be varied between 10% and 75%.

In a third step, as can be seen in FIG. 2A, the first polymer and aggregate mixture 201 is added to the mould 101, to depth ‘E’ (which, in this example is 3 mm), to form the upper portion of the resulting tactile tile (i.e. the peaks of the resulting tactile profiles which represent the second layer). That is, the open topped mould 101 is partially filled with a predetermined volume of the first polymer and aggregate mixture 201.

In a fourth step, the first polymer and aggregate mixture 201 is left for a predetermined time. The predetermined time is sufficient (in this example that is approximately 20 minutes, though, in other examples a different amount time may be required) for the polymer and aggregate mixture 201 to cross-link such that a surface resistance develops. The predetermined period of time should be long enough that the surface resistance should be of sufficient strength to prevent the second polymer and aggregate mixture 202 (when it is added to the mould 101 on top of the first polymer and aggregate mixture 201) from penetrating the first polymer and aggregate mixture 201 such that the colours of the first and second polymer and aggregate mixtures mix. However, the second polymer and aggregate mixture 202 must cross link with the first polymer and aggregate mixture 201 such that they are bonded to minimise risk of delamination. Therefore, once poured, the first polymer and aggregate mixture 201 is not left for substantially longer than 20 minutes before the second polymer and aggregate mixture 202 is added. That is the predetermined time can be approximately 20 minutes.

In a fifth step, the second polymer and aggregate mixture 202 is mixed. The second polymer and aggregate mixture 202 is coloured with a second colour. The mixture comprises a pre-mixed two-part polyurethane liquid (the polymer), and combination of quartz and/or glass beads (the aggregate) at a 50% weight/weight aggregate to polymer ratio. The two-part polyurethane liquid has for example a yellow coloured pigment mixed therein such that the resulting second polymer and aggregate mixture 202 is visibly distinguishable from the first polymer and aggregate mixture 201.

In a sixth step, as can be seen in FIG. 2B, the second polymer and aggregate mixture 202 is added into the volume 103 (on top of the first polymer and aggregate mixture 201 to form the first layer) until it is filled up to the level of the surface 102. That is, the open topped mould 101 is filled with a predetermined volume of the second polymer and aggregate mixture 202.

As the first polymer and aggregate mixture 201 and the second polymer and aggregate mixture 202 cure, they crosslink such that they are bonded to form a single tactile tile corresponding to the shape of the cavity 103. Once cured, the tactile tile is removed from the mould 101. The resulting tactile tile is shown in FIGS. 3A and 3B.

FIG. 3A provides a simplified schematic diagram of a tactile tile 301 formed in accordance with the process described with reference to FIGS. 1A to 2B. FIG. 3B provides a simplified schematic diagram of a side view of the tactile tile 301.

As can be seen from FIGS. 3A and 3B, the tactile tile 301 comprises a floor surface 305 and nine tactile profiles 304 protruding from the floor surface 305 which correspond in shape to the recesses 106.

As can be seen from FIG. 3B, the tactile tile 301 is comprised of a first material 302 (corresponding to the second polymer and aggregate mixture 202 which contains yellow pigment), and a second material 303 (corresponding to the first polymer and aggregate mixture 201) of a different colour. The transition point at which the material (and therefore the colour) changes is 3 mm above the floor surface 305. The first material 302 represents the first layer of the tactile alert system and the second material 303 represents the second layer of the tactile alert system.

The transition point is set at 3 mm because it corresponds with the tactile profile height which is detectable underfoot. As such, maintenance personnel can interpret a change of colour of the tactile profiles 304 as an indication that the amount with which the tactile profiles 304 are protruding from the floor surface has been reduced to less than or equal to 3 mm (for example, as a result of wear from foot traffic) and are therefore due for maintenance (for example, replacement or topping up which is described with reference to FIGS. 7A to 9D).

As can be seen from FIG. 3B, the total thickness of the tactile tile 301 (from the base of the of the tactile tile 301 to the top of the tactile profiles 304) is between 9.5 mm and 10 mm assuming a base height of 4 mm.

In the above example described with reference to FIGS. 2A and 2B, the mixtures comprise a polymer and an aggregate. The polymer is described as a two-part polyurethane liquid, however, the polymer in the mixture can comprise, for example, any suitable thermoset or thermoplastic polymer (in a liquid state), though, preferably a polyurethane, acrylic, polyester or epoxy resin. The aggregate is described as being quartz. However, the purpose of the aggregate is to provide anti-slip and improved wear properties to the resulting material of the tile, as such, other suitable aggregates can be used, for example, flint, emery, carborundum, aluminium oxide, or glass. Though, preferably quartz, aluminium oxide or glass beads are used in isolation or in combination as the aggregate. It will be understood that a polymer mixture without an aggregate can be used.

The pigment used to colour the polymer in the mixes can be organic or inorganic.

FIG. 3C provides a simplified schematic diagram of a tactile tile 306 formed in accordance with certain embodiments of the invention. FIG. 3D provides a simplified schematic diagram of a tactile tile 308 formed in accordance with certain embodiments of the invention comprising linear tactile profiles 309, as in a cycle tactile.

In the embodiments described with reference to FIGS. 3A and 3B, the tactile tile comprises a total of nine hemispherical tactile profiles (or ‘blisters’). However tactile tiles with different numbers of blisters can be formed in the same way. For example, the tactile tile 306, shown in FIG. 3C, provides an example of a tactile tile of typical dimensions; ‘A’ and ‘B’ would typically be set equal to each other to form a square with sides of length 400 to 450 mm, for example. The tactile tile 306 comprises thirty-six blister-type tactile profiles 307 formed in accordance with the techniques described with reference to above embodiments (i.e. comprising multiple layers of different colours to indicate wear below 3 mm from the floor surface of the tactile tile).

Further, different types of tactile profile (such as, ‘corduroy’, ‘guidance’, ‘cycle’) can be formed in the same way (i.e. comprising multiple layers of different colours to indicate wear below 3 mm from the floor surface of the tactile tile). For example, the tactile tile 308 shown in FIG. 3D comprises linear tactile profiles 309 (cycle-type profiles which could be configured to highlight a cycle track when used in conjunction with a segregated path comprising a foot path and a cycle track), each of which is formed from two different coloured polymer/aggregate mixes such that there is a visible transition between the colours at a height of 3 mm from the floor surface from which the tactile profiles 309 protrude.

In the above embodiments, the tactile profiles are formed as part of a tactile tile. These tactile tiles can be configured to be surface mountable. Further, in certain embodiments of the invention the tactile profiles can be formed independently of a surface and subsequently surface mounted to existing floor surfaces; each of the one or more tactile profiles comprising a first layer and a second layer which are visibly distinguishable from each other (by virtue of being different colours). The second layer is positioned over the first layer such that when the second layer is worn away, the first layer becomes visible.

In the above embodiments the transition point at which the change in colour occurs is set at 3 mm from the floor surface from which the tactile profiles protrude because when tactile profiles are worn below a level of 3 mm it is difficult to detect them underfoot. As such, when wear of this level occurs, visually impaired people can have great difficulty identifying the presence of the worn tactile profiles. However, it will be understood that in accordance with certain embodiments of the invention different distances from the floor surface can be used for the transition between the first layer and the second layer (and the resulting colour change). For example, a green layer can be used from a vertical height range between 4 mm to 6 mm, with an intermediate ‘amber’ layer with a vertical range between 2 mm to 4 mm and a ‘red’ layer with a vertical range between 0 mm and 2 mm.

### Glow in the Dark Tactile Alert System

FIG. 4A provides a simplified schematic diagram of a tactile tile 401 manufactured in accordance with certain embodiments of the invention. FIG. 4B provides a simplified schematic diagram of a side profile of the tactile tile 401.

The tactile tile 301 described with reference FIGS. 3A and 3B is manufactured such that it comprises two different materials, each material a different colour. Specifically, the tactile profiles which comprise an upper portion and a lower portion are formed in different colours such that a visible change in colour of a given tactile profile indicates that the tactile profile has been worn below an unacceptable level. Using a similar manufacturing technique (that is, using two separate mixtures to form a single tile), in accordance with certain embodiments of the invention, an alternative tactile tile 401 is formed.

The tactile tile 401 comprises a base 405 comprising a floor surface 404 from which a linear ‘glow-in-the-dark’ tactile bar 403 and four standard (non-glow-in-the-dark) linear tactile bars 402 protrude.

As can be seen in FIG. 4B, the glow-in-the-dark tactile bar 403 comprises an upper part 406a and a lower part 406b. The upper part 406a is formed from glow-in-the-dark material and the lower part 406b is formed from a different (non-glow-in-the-dark) material in the same colour as the base 405. Both, the upper part 406a and the lower part 406b, are 3 mm thick.

FIG. 5A provides a simplified schematic diagram of an open topped mould 501 for manufacturing the tactile tile 401. FIG. 5B provides a simplified schematic diagram of a cross section of the open topped mould 501. FIG. 5C provides a simplified schematic diagram depicting the addition of a glow-in-the-dark mixture to a single channel of a chamber 503 of the open topped mould 501. FIG. 5D provides a simplified schematic diagram depicting the addition of a non-glow-in-the-dark mixture to the chamber 503 until it is filled.

The open topped mould 501 comprises a chamber 503 in which the tactile tile 401 is formed. The chamber 503 corresponds with the chamber 103 with the exception that, instead of the hemispherical recesses 106 there are five channels 502a 502b 502c 502d 502e recessed into the chamber 503 running in parallel (and equally spaced apart) along a length of the chamber 503.

The tactile tile 401 is formed in substantially the same way as the tactile tile 301 with the exception that the first polymer and aggregate mixture 504 now contains a glow-in-the-dark polymer and is only added to a single outer channel (in this case channel 502e). The second polymer and aggregate mixture 505 is then prepared and added to the chamber 503 until it is filled (in the same way as described with reference to FIGS. 2A and 2B).

The polymer in either the first and second mixtures can comprise, for example, any suitable thermoset or thermoplastic polymer (in a liquid state), though, preferably a polyurethane, acrylic, polyester or epoxy resin. Any suitable aggregate (that provides anti-slip and improved wear properties to the resulting material) can be used in the mixtures, for example, quartz, flint, emery, carborundum, aluminium oxide, or glass. Though, preferably quartz, aluminium oxide or glass beads are used in isolation or in combination as the aggregate.

Advantageously, visually impaired (or normally sighted) people for whom it is difficult to perceive changes in colour in certain settings with reduced lighting or darkness can observe the glow-in-the-dark tactile bar 403. As such, tactile tiles comprising glow-in-the-dark tactile bars can be used to highlight hazards in those circumstances.

FIG. 6A provides a simplified schematic diagram showing two tactile tiles 401a and 401b (each of which correspond with the tactile tile 401 described with reference to FIGS. 4A and 4B) positioned adjacent one another.

By virtue of only including the glow-in-the-dark material in a single tactile bar 403, a path can be formed with a glow-in-the-dark edge for guidance by fitting tactile tiles 401a and 401b adjacent one another, as can be seen in FIG. 6A, such that the glow-in-the-dark bars 403a and 403b together form a longer glow-in-the-dark tactile bar running along a side of the tactile tiles 401a and 401b. In this way, the combination of multiple tiles results in a pathway with a glow-in-the-dark edge which can be used to help pedestrians and cyclists, for example, to navigate hazards (such as, a platform edge, cycle path, or change of height of floor surface); or to remain on a certain side of a path. A pathway can be created using polymer with an alternative (preferably brightly coloured) pigmentation in place of the glow-in-the-dark polymer. However, this would not necessarily have the same level of visibility in low-light conditions.

Advantageously, highlighting hazards using the tactile tiles with glow-in-the-dark profiles in this way increases safety of the visually impaired in low light settings. This can be of particular benefit in emergency situations. The glow-in-the-dark properties of the tactile tiles are also beneficial for pedestrians with normal sight and cyclists who are travelling in subdued light or darkness.

For a segregated pathway such tactile tiles (glow in the dark or otherwise) can be used to position the visually impaired to walk on one side of a pathway and cyclists on the other side. Preferably, the tactile tiles over which cyclists will ride are oriented such that the tactile bars run parallel with the direction of travel (so that the ride over the tactile tiles is smoother). In contrast, the tactile tiles over which pedestrians will walk are oriented such that the tactile bars run perpendicular to the direction of travel. In this way, a clear distinction is made between the portion of the pathway designated for cyclists and that designated for pedestrians. Further, orienting the tactile bars such that they run perpendicular to the direction of travel ensures that the tactile bars are more readily felt underfoot (and by cyclists) such that it is clear from touch alone which pathway is which.

By virtue of the visual contrast between the glow-in-the-dark material of the upper part 406a and non-glow-in-the-dark material of the lower part 406b a visible change in photoluminescent properties of the tactile bar 403 indicates that it has been worn down below a height of 3 mm or less (from the floor surface from which it protrudes). From this, it can be inferred that the other tactile bars 402 have also worn down to a height of below 3 mm and as such also require repair or replacement.

In the embodiments described with reference to FIGS. 4A to 6A only the upper portion of a single tactile profile is filled with single glow-in-the-dark material. In certain embodiments of the invention the full depth of the same tactile profile can be filled with glow-in-the-dark material. Further, in certain embodiments, instead of linear tactile profiles such as tactile bar 403, tactile blisters are filled (or partially filled) with glow-in-the-dark material to provide guidance in low light settings.

### Top-Up Technique

As described above, when tactile profiles of tactile tiles are worn to a level below 3 mm from the floor surface from which they protrude it is difficult to detect them underfoot. As such, when wear of this level occurs, visually impaired people can have great difficulty identifying the presence of the worn tactile profiles. Currently, the solution to this problem is typically to replace the tactile tiles from which the tactile profiles protrude.

However, in accordance with certain aspects of the invention there is provided a method of ‘topping up’ tactile profiles of tactile surfaces (such as the tactile tiles described with reference to FIGS. 3A to 4B) in-situ. This process involves reinstating one or more of the tactile profiles to a pre-worn form via of a three dimensional ‘female stencil’ which is a female mould within which top up material can be applied to worn tactile profiles. The female stencil comprises a plurality of cavities (each of which shaped to correspond with a tactile profile in its pre-worn form) each cavity comprising an aperture through which a liquid mix can be transferred into the mould. This method can be used to reinstate tactile profiles on existing tactile surfaces including: tactile mats, concrete pavers, ceramic surfaces, or FRP/GRP surfaces. For example, this method can be used to reinstate the second layer of the tactile alert systems described with reference to FIGS. 1A to 6A when the visible change in colour of one or more tactile profiles indicates that the tactile alert system has been worn to an unacceptable level.

FIG. 7A provides a simplified schematic diagram depicting a first step in forming a female mould. FIG. 7B provides a simplified schematic diagram depicting a subsequent step in forming the female mould. FIG. 7C provides a simplified schematic diagram depicting a cross section view of a subsequent step in forming the female mould. FIG. 7D provides a simplified schematic diagram depicting a cross section of a subsequent step in forming the female mould.

The female mould is formed according to the steps described with reference to FIGS. 7A to 7D, as follows.

In a first step, a tactile tile 701, of the same geometry as the tactile tile to be repaired (i.e. the tactile tile 701 represents the original form (i.e. the pre-worn form before wear has occurred) of the tactile tile to be repaired) is fixed to a base 702 (for example, via adhesive or mechanical fixings).

In a second step, side panels 703a 703b 703c 703d are fixed together at their respective ends and to the base 702 (for example, via adhesive or mechanical fixings). The tactile tile 701 corresponds to the tactile tile 301 and has a floor surface 705 from which tactile profiles 704 protrude.

The base 702 and side panels 703a 703b 703c 703d can be made from any suitable material such as wood, ceramic, metal, plastic, glass or preferably from any impervious material. Where the material is porous the material is sealed with a sealant (suitable to provide an impervious barrier) and allowed sufficient time to cure until dry. The tactile tile 701 can be made from any material suitable for forming into a male mould around which the female mould can be formed, for example, concrete, ceramic, rubber or plastic.

As can be seen from FIG. 7A, the base 702 is of the same length and width as the tactile tile 701. As can be seen in FIG. 7C (which is a cross-section view of the arrangement shown in FIG. 7B), the side panels 703a 703b 703c 703d fit snugly against the sides of the tactile tile 701 and extend upwardly to approximately the same level as the top of tactile profiles 704 of the tactile tile 701 to create an open topped ‘bund’ (i.e. a chamber bounded by the floor surface 705 and the side panels 703a 703b 703c 703d within which the female mould will be formed). The side panels 703a 703b 703c 703d may extend upwardly above the level of the top of the tactile profiles 704 of the tactile tile 701 in other embodiments of the invention.

In a third step, release agent is applied over the surface area of the chamber and allowed sufficient time to dry. The purpose of the release agent is to prevent the female mould from sticking to the chamber, during the curing of the female mould, such that it can be released from the chamber in a single piece.

In a fourth step, a liquid elastomer 706 is poured into the chamber, as can be seen in FIG. 7D, until the level of the liquid elastomer 706 reaches approximately 0.5 mm from the top of the tactile profiles 704. That is, the tactile profiles 704 are left uncovered by the liquid elastomer 705 (protruding above the exposed surface of the elastomer 706 by 0.5 mm). In this way, apertures will be formed in the resulting female mould (where the tops of the tactile profiles 704 prevent the elastomer 706 from forming a surface) through which ‘top up’ material can be transferred (to repair worn tactile tiles).

An elastomer 706 is used because it is preferable that the resulting mould is flexible when cured (for ease of removal and subsequent application to worn tactile tiles). However, any other material which is suitable for use in moulding and is suitably flexible can be used.

The elastomer 706 is allowed time to cure thereby forming the female mould which is then removed from the chamber. The resulting female mould is shown in FIGS. 8A to 8D.

FIG. 8A provides a simplified schematic diagram of a female mould 801 resulting from the moulding process described with reference to FIGS. 7A to 7D. FIG. 8B provides a simplified schematic diagram of a central cross-sectional view of the female mould 801. FIG. 8C provides a simplified schematic diagram of a top view of a first side 801a of the female mould 801. FIG. 8D provides a simplified schematic diagram of a top view of a second side 801b of the female mould 801.

The female mould 801 has formed therein substantially hemispherical recesses 803 which are cavities which were formed around the portions of the tactile profiles 704 which were submerged in the elastomer 706 during the formation of the female mould 801 and as such substantially correspond in shape to said portions. The female mould 801 has formed therein apertures 802 through which top up material can be transferred from the second side 801b into the recesses 803. The apertures 802 were formed by virtue of allowing the peaks of the tactile profiles 704 to protrude above the exposed surface of the elastomer 705 during the moulding process. As such, each aperture is concentrically located, at the deepest part, within each respective hemispherical recess/cavity.

FIG. 9A provides a simplified schematic diagram depicting application of the female mould 801 to a worn tactile tile 901. FIG. 9B provides a simplified schematic diagram showing the female mould 801 when applied to the worn tactile tile 901. FIG. 9C provides a simplified schematic diagram showing a central cross-sectional view of the arrangement shown in FIG. 9B before a top-up mix has been applied. FIG. 9D provides a simplified schematic diagram showing the central cross-sectional view shown in FIG. 9C when a top-up mix 905 has been applied. FIG. 9E provides a simplifies schematic diagram of the ‘topped up’ tactile tile 901.

The worn tactile tile 901 has nine tactile profiles 902 which have been worn down such that they no longer protrude from the floor surface 903 by 3 mm or more and as such are difficult to detect underfoot. In accordance with certain embodiments of the invention, a top up process can be performed whereby a top up material is applied, via the female mould 801, to the tactile profiles 902, in situ, such that they are returned to substantially their original form (and are therefore more easily detectable underfoot). In this way, the tactile profiles 902 are reinstated. This process is described as follows.

In a first step, the surfaces of tactile profiles 902 are mechanically prepared in situ (for example, by using a sanding tool, grinding tool or other suitable abrading device) to create a textured surface to improve the adhesion between the tactile profiles 902 and the top-up mix 905 to be applied. Dust can be removed using a vacuum device. Residual dust and dirt is removed from the tactile profile surface using a suitable cleaner/detergent/solvent. Preferably a solvent is used such that minimal residue is left on the surface of the tactile profiles 902. Minimising the residue left on the worn tactile profiles increases adhesion between the top-up mix and the worn tactile profiles 902.

In a second step, the female mould 801 is located on top of the worn tactile tile 901 and aligned such that the recesses 803 align over the worn tactile profiles 902, as can be seen in FIGS. 9B and 9C. The worn tactile profiles 902 and the corresponding recesses 803 fit snugly together to form a fluid tight connection such that fluid tight cavities 904 are formed above the tactile profiles 902. That is, the worn tactile profiles are located within corresponding cavities (recesses 803) of the mould. The only openings into the cavities 904 are provided by the apertures 802.

In a third step, liquid top-up mix 905 is mixed and transferred into the cavities 904 via apertures 802 until the cavities 904 are completely filled with the top up liquid 905. This can be performed, for example by moving the liquid top-up mix 905 across the surface 801b of the female mould 801 such that it flows through the apertures 802 into the cavities 904. The surface 801b is then smoothed with a flat applicator tool to ensure a smooth and level finish of the top-up mix 905 atop the tactile profiles 902.

The top-up mix 905 is then allowed sufficient time to cure and the female mould 801 is removed leaving the cured top-up material in place atop the tactile profiles 902, as can be seen in FIG. 9E, which shows the tactile profiles 902 replenished to their original form (i.e. such that the tactile profiles 902 are now blister-type profiles which protrude from the floor surface 903 by approximately 5.5 mm-6 mm). During curing the, the top up mix 905 adheres to the surface of the worn tactile profiles such that the top up mix 905, when cured, forms reinstated tactile profiles that are secure to withstand foot traffic in substantially the same way that pre-worn tactile profiles would be able to.

The mould 801 can be removed before the top-up mix 905 has fully cured but is sufficiently cured to maintain its form without the mould 801 in place.

The top-up mix 905 can be provided by a polymer, for example, any suitable thermoset or thermoplastic polymer (in a liquid state), though, preferably a polyurethane, acrylic, polyester or epoxy resin.

Aggregate (such as, quartz, flint, emery, carborundum, aluminium oxide, or glass) can be mixed in with the top up mix 905 to provide for anti-slip and improved wear properties, hereto referred to as the ‘top-up mix’. The preferred aggregates include quartz, flint, emery, carborundum, aluminium oxide, or glass. More preferably quartz, aluminium oxide and glass are used in isolation or in combination.

In this example, the top-up mix 905 comprises a pre-mixed two-part polyurethane liquid (the polymer), and quartz (the aggregate) at a 50% weight/weight aggregate to polymer ratio.

To prevent the top-up mix 905 leaking from the cavities 904, the top-up mix 905 can be thickened using a suitable thickening agent such as calcium carbonate, silica or other suitable materials. Preferably silica is used to thicken up the top-up mix 905 as it also helps maintain the flowability of the top-up mix 905.

In the above embodiment, nine tactile profiles are topped up contemporaneously. However, in certain embodiments of the invention, a female mould is constructed for a single tactile profile, such that, single tactile profiles can be topped up individually.

It will be understood that the worn tactile tile 901 can represent a tactile alert system such as that described with reference to FIGS. 1A to 6A where the worn tactile profiles 902 represent the first layer which has been revealed as the second layer has worn away. The method steps described with reference to FIGS. 9A to 9E (i.e. topping up/reinstating the tactile profiles to a pre-worn form) would be performed when, by virtue of the visible change in colour of the tactile profiles, maintenance personnel have been alerted that the tactile profiles 902 have been worn to a level which is undetectable underfoot. Then, performing the steps described with reference to FIGS. 9A to 9E (i.e. topping up/reinstating the tactile profiles to a pre-worn form) substantially reinstates the second layer over the first layer of the tactile alert system.

In certain embodiments, the top-up system be used to top up alternate existing tactile tiles such as those formed from concrete.

It will be understood, that in the formation of (or topping up of) any of the above tactile surfaces or tactile profiles, a liquid polymer may be used on its own or in combination with one or more aggregates.

### Surface Mounted Tactile Installation

As described above, installation of surface mounted tactile tiles to existing floor surfaces has become more cost effective than installing traditional concrete paving slabs. These tactile tiles can be bonded to floor surfaces via adhesive systems. However, if during installation of the tactile tiles the adhesive systems are exposed to moisture and cold conditions, the adhesive strength can be reduced which can lead to delamination of the tactile tile. As such, in accordance with certain aspects of the invention, there is provided a shelter system for the improvement of installation of surface mounted tactile tiles in inclement weather conditions, such as wet or cold weather. The shelter system is configured to shelter a substrate (any floor surface to which tactile tiles are to be installed, such as. a platform, or pathway) whilst tactile tiles are prepared and adhered to the substrate.

FIG. 10A provides a simplified schematic diagram of a three-dimensional structure 1002 for supporting a shelter system 1001 arranged in accordance with certain embodiments of the invention. FIG. 10B provides a simplified schematic diagram of the shelter system 1001 arranged in accordance with certain embodiments of the invention. FIG. 10C provides a simplified schematic diagram of the shelter system 1001 with a pocket 1006 positioned around the perimeter of its base.

The shelter system 1001 comprises a rigid three-dimensional structure 1002 which is covered by material 1003 thereby covering an area of floor surface to which tactile tiles are to be adhered. The structure 1002 is configured to support the cover material 1003. The inner volume bounded by the material 1003 forms a chamber 1004 within which tactile tiles can be installed to the floor surface contained therein. The material 1003 has formed therein an openable portion 1005 which can act as a doorway to allow entry into (and exit from) the chamber 1004 for installers using the shelter system 1001. The openable portion 1005 can be provided by, for example, a flap of the material 1003. The openable portion 1005 can be provided on any side of the shelter system 1001.

The structure 1002 is constructed from galvanised steel tubing with a thickness of approximately 40 mm. Advantageously, galvanised steel is resistant to rusting and is of sufficient weight to ensure that the shelter system 1001 remains stable in winds of up to 50 mph. The height of the shelter system 1001 (dimension ‘A’ in FIG. 10B) is approximately two metres; the length (dimension ‘B’ in FIG. 10B) is approximately two metres; and, the width (dimension ‘C’ in FIG. 10C) is approximately one metre.

The structure 1002 can be constructed from any other suitable material (for example, other metals (e.g. aluminium), wood, glass/fibre reinforced polymer (GRP/FRP), expanded foam, or plastic) provided the material can provide a stable support for the shelter system 1001. Preferably, the material is heavy enough to resist high winds and resistant to corrosion (such as rusting) associated with outdoor use. Further, any suitable dimensions (‘A’, ‘B’, and ‘C’) can be used provided that ‘A’ is sufficient to provide headroom from installers using the shelter system 1001 and ‘B’ and ‘C’ are sufficient to facilitate installation of tactile tiles therein (for example, ‘C’ should allow for at least twenty centimetres either side of tactile tiles to be installed) but typically not too wide because use of the shelter system may be required in narrow locations such as railway stations in which access is restricted by blast bollards which are set a distance of two metres apart.

The material 1003 can be any material which is resistant to water such as canvas, rubber or plastic. Preferably the material is canvas or plastic.

The material 1003 is pulled taut over the structure 1002 and tied (for example to the structure or to external fixing points) at appropriate spacing, to provide a taut cover in which there are no slack areas in which pools of water could form.

Advantageously, by virtue of the waterproof properties of the material 1003 it inhibits rain/snow ingress into the chamber 1004.

As can be seen in FIG. 10B, the material 1003 is extends all the way to the floor surface on which the shelter system 1001 is located. That is, the material 1003 in the direction of ‘A’ is dimensioned larger than the height of the structure 1002 such that there is an overhang running around the perimeter of the base of the shelter system 1001. The overhang contacts the floor around the perimeter of the shelter system 1001 to form a substantially fluid tight seal such that excess water (such as rainwater) external to the shelter system 1001 does not enter the chamber 1004. That is, the overhang provides a barrier between the surface water accumulated on the floor surrounding the shelter system 1001 and the chamber 1004 thereby inhibiting water ingress onto the area of the substrate to which tactile tiles are to be adhered.

To ensure the overhang makes sufficient contact with the floor to minimise ingress of water, the overhang can be weighted, for example, as can be seen in FIG. 10C, where a pocket 1006 is formed within the overhang (running around the perimeter of the shelter system 1001) which is filled with a heavy material such that a substantially fluid tight seal is formed between the overhang and the floor surface on which the shelter system 1001 is located.

The heavy material can be provided by a weighted mass, for example, an aggregate such as sand which would be ‘filled’ into the pocket surrounding the base of the shelter until sufficient weight has been reached to ensure sufficient contact between the overhang and the floor surface on which the shelter system 1001 is located such that a substantially fluid tight seal is formed between the overhang and the floor around the perimeter of the shelter system 1001. In this way, the pocket would be sufficiently versatile to seal even an undulating floor. Alternatively, the heavy material can be provided by a rod or chain (made of metal), wood or glass reinforced polymer provided sufficient contact is made between the between the overhang and the floor surface on which the shelter system 1001 is located such that a substantially fluid tight seal is formed between the overhang and the floor around the perimeter of the shelter system 1001.

Advantageously, by virtue of the shelter system 1001, surface mounted tactile tiles can be installed on the floor surface contained within the chamber 1004 irrespective of certain inclement weather conditions.

Further, the shelter system 1001 can further comprise a heating system configured to heat the area of the substrate to which tactile tiles are to be adhered to reduce the risk of delamination.

The structure 1002 is cuboidal, shown in FIG. 10A is cuboidal. However, alternative structures can be used which are formed into different shapes provided there is sufficient headroom for installers using the resulting shelter system and sufficient floor space for installing tactile tiles.

FIG. 11A provides simplified schematic diagram of a shelter system 1101 arranged in accordance with certain embodiments of the invention. FIG. 11B provides a simplified schematic diagram of a top view of the shelter system 1101. FIG. 11C provides a simplified schematic diagram of certain components of a heating system housed within the shelter system 1101.

The shelter system 1101 comprises four sections: a heating section 1102, a first shelter section 1103, a second shelter section 1104, and a storage section 1105. The four sections are joined by link sections 1106 which are watertight passages through which tactile tile installers can move between the sections. The first shelter section 1103 and second shelter section 1104 in combination can also be referred to as the adhering section, because under the cover of these sections, tactile tiles are adhered to floor surfaces.

The first shelter section 1103 and the second shelter section 1104 substantially correspond to the shelter system 1001 described with reference to FIGS. 10A-10C with the exception that there are openings are provided at each end to provide access to the relevant link sections 1106. The heating section 1102, storage section 1105, and link sections 1106 are constructed in substantially the same way as the first and second shelter sections 1103 and 1104 (that is, a galvanised steel structure is covered with a water-resistant material covering).

Castor wheels 1107 are fixed to each section of the shelter system 1101 (one fixed at each corner of each respective base of each galvanised steel structure) such that the shelter system 1101 is mobile. In this way, the shelter system 1101 can be moved along a path to which tactile tiles are to be installed. Each castor wheel 1107 comprises a brake (which together form a brake system) such that the shelter system 1101 can be held stationary when installers are installing tactile tiles within it. The brake system is sufficient to prevent the shelter 1101 from moving in winds of up to 50 mph.

The heating section 1102 comprises a heating arrangement comprising two heating systems, each of which comprising a gas cylinder 1108, rubber tubing 1109, and a multi-head gas torch 1110, as can be seen in FIG. 11B. FIG. 11C shows certain additional components of either heating system shown in FIG. 11B. As can be seen from FIG. 11C, the heating system comprises a pressure reducing valve 1111, a flow control valve 1112; the multi-head gas torch 1110 comprises four gas burner heads 1113.

As most adhesives used to bond the tactile tiles to a floor surface are affected by adverse weather conditions, such as moisture or cold temperatures, then it is advantageous to heat the floor surface prior to laying the adhesive.

The rubber tubing 1109 provides a fluid tight connection between the gas cylinder 1108 and the multi-head gas torch 1110, such that gas from the cylinder 1108 can be fed to the multi-head gas torch 1110 to be ignited by an ignition source. The pressure reducing valve 1111 and the flow control valve 1112 are connected to the rubber tubing 1109. The pressure reducing valve 1111 is configured to reduce the pressure of the gas fed to the flow control valve 1112 to a suitable level (for safe and optimal operation of the multi-head gas torch 1110). The flow control valve 1112 is operable by hand to be either in a fully open configuration (in which gas is free to flow relatively unimpeded, by the flow control valve 112, from the gas cylinder 1108 to the multi-head gas torch 1110); a fully closed configuration (in which flow of gas from the gas cylinder 1108 is prevented); and, somewhere therebetween (i.e. where the flow control valve 1112 is partially open thereby allowing a reduced amount of gas to flow from the gas cylinder 1108 to the multi-head gas torch 1110).

It will be understood that the heating systems shown schematically in FIG. 11B can be housed within the heating section 1102 in any suitable way such that when the heating systems are in use (i.e. the flow control valves 1112 are full or partially open and the flowing gas is ignited, via an ignition source, at the burner heads 1113 to produce heat) the heat produced heats the floor surface over which the heating section 1102 is positioned sufficiently to dry it. The heating systems can be supported within the heating section 1102 by, for example, additional galvanised steel framework fabricated as part of the steel structure to which the covering is fixed. Further, the multi-head gas torch can be surrounded by an insulating box to minimise heat loss.

The heating arrangement described above comprises two heating systems, however, it will be understood that other numbers of heating systems can be used (or alternate numbers of burner heads in each gas torch) provided they can sufficiently dry the surface to which tactile tiles are to be installed.

The heating systems are used to heat the floor area to which adhesive (for installing tactile tiles) is to be applied. The heating is performed to evaporate moisture (for example, rainwater or snow) and thereby reduce the risk of delamination of subsequently applied tactile tiles. As such, it will be understood that the heating systems can instead be provided by alternate means (for example, infrared heat) provided such means are capable of drying the floor sufficiently for tactile tile installation without causing damage to the floor. The multi-head gas torches can be arranged in any special formation, such as adjacent to each other to cover a wider area or doubling/trebling up in rows to produce more heat per unit area to evaporate the moisture more quickly.

The storage section 1105, is used to store surface mounted tactile tiles which are to be installed and adhesive which will be used during the installation. The adhesive is stored in plastic buckets and the tactile tiles are stored in cardboard boxes (with ten tactile tiles stored in each box). Each tactile tile is a 400×400 mm square with a thickness of 10 mm or less. The volume of adhesive stored in each plastic bucket is sufficient to adhere 10 tactile tiles to a floor surface (which is equivalent to a four-metre length of tactile tiles). This length substantially corresponds with the combined length of the first shelter section 1103 and the second shelter section 1104 such that, when the shelter system 1101 is stationary, a full box of tactile tiles can be installed, in a line, to the floor surface within the first and second shelter sections 1103 and 1104 using a full bucket of adhesive.

Advantageously, by virtue of the mobility of the shelter system 1101, surface mounted tactile tiles can be installed along long sections without the requirement to isolate the entire section. That is, the shelter system 1101 can be moved along an installation path along which tactile tiles are to be installed. The gas heating system is positioned at the front of the shelter system (with respect to the direction of travel along the installation path) such that whilst the shelter system 1101 is moved along the installation path, the gas heating system can be used to heat (and therefore dry) upcoming portions of the path on which tactile tiles are to be mounted. For example, the heating system can be used to dry a predetermined surface area of the path which corresponds in dimension to the adhering section in which tiles are subsequently installed on that surface area. The tactile tiles can subsequently be installed on the dried portions of the installation path under the cover of the shelter sections 1103 and 1104 which prevent ingress of further water. This process is described in more detail with reference to FIGS. 12A, 12B, and 12C.

FIG. 12A provides a simplified schematic diagram of a shelter system 1201 in a first position on a railway platform 1206. FIG. 12B provides a simplified schematic diagram of a shelter system 1201 in a second position on the railway platform 1206. FIG. 12B provides a simplified schematic diagram of the shelter system 1201 in a subsequent position on the railway platform 1206.

The platform 1206 comprises a platform edge 1203 which runs alongside a rail track 1202 in parallel with it.

The shelter system 1201 substantially corresponds to the shelter system 1101 described with reference to FIGS. 11A to 11C. The shelter system 1201 is pre-loaded with requisite gas (for the heating system), tactile tiles, and adhesive. In order to install tactile tiles 1205 to the surface of the railway platform 1206, the shelter system 1201 is moved along an installation path in parallel with the platform edge 1203 at a predetermined rate. Whilst moving along the path, the heating section heats (and dries) upcoming portions of path to which tactile tiles are to be installed. Once the shelter system 1201 has been moved a predetermined amount (corresponding to the length of the adhering section), the shelter system 1201 is stopped and held in place by a braking system; tactile tiles are installed to the portion of the installation path covered by the adhering section. This process is repeated to produce a continuous stretch of tiles (of required length) along the installation path. This process is described in more detail, as follows.

In a first step, guide bars 1204 are installed along the length of the platform 1206, running in parallel with the platform edge 1203 and separated from it by distance ‘A’ which is typically approximately 1.4 metres. The guide bars 1204 are each approximately four metres long (approximately five guide bars 1204 are shown installed in each of FIGS. 12A to 12C). The purpose of the guide bars 1204 is to provide a guide for the castor wheels of the shelter system 1201 to prescribe its movement in lateral directions. The reasons for prescribing lateral movement of the shelter system 1201 in this way are twofold: firstly, to ensure that the tactile tiles 1205 are installed in parallel with the platform edge 1203 (in this example the tactile tiles 1205 are centred at a distance of approximately 0.7 metres from the platform edge 1203); and, secondly to ensure that the castor wheels cannot move towards the platform edge 1203 (and therefore the rail track 1202).

The guide bars 1204 can be installed in any appropriate way (for example, via adhesive or mechanical fixings at either end) provided they are fixed sufficiently to prevent the castor wheels of the shelter system 1201 from moving across them or dislodging them. Mechanical fixings (such as screws or bolts) are preferable because they can be installed in inclement weather and can be removed from the platform 1206 (when installation of the tactile tiles 1205 is complete) with minimal damage to the platform 1206. Alternatively, sand bags can be placed over the guide bars where damage to the platform is not permitted.

The guide bars can be made from stainless or galvanised steel.

In a second step, the flow control valves of the shelter system 1201 are opened (either partially or fully, as required) and the multi-head gas torches are ignited via the ignition source. The heating section is moved along a predetermined distance which is the first portion (‘P1’ shown in FIGS. 12A and 12B) of the installation path (in direction ‘B’) at a prescribed rate. The distance ‘P1’ corresponds approximately to the length of the adhering section. The first portion is approximately four metres long. The prescribed rate and the amount that the flow control valves are opened are selected such that, as the shelter system 1201 is moved, the heat produced by the heating system dries the floor surface of platform 1206 (sufficiently to allow adhesion of tactile tiles thereto) along the first portion P1 of the installation path.

Advantageously, the heating system provides a consistent means of sufficiently drying the floor surface to which the tactile tiles are to be installed thereby minimising risk of delamination of the tactile tiles. Further, by virtue of arranging the heating system in advance of the first and second shelter sections (with respect to the direction of travel along the installation path), where the floor surface is already wet, the heating system can heat (and therefore dry) upcoming portions of the installation path to which tactile tiles are to be adhered in the adhering section.

In a third step, the brakes are applied to the castor wheels of the shelter system 1201 thereby holding the shelter system 1201 at a first position (shown in FIG. 12A) at which the first and second shelter sections of the shelter system 1201 (collectively, the adhering section) are located substantially over the first portion of the installation path (which has been dried by the heating system).

In a fourth step, inside the adhering section (which is under cover), the perimeter of the floor surface area (which has been dried by the heating system) to which tactile tiles are to be installed is lined with tape (to prevent excess adhesive from spilling into areas of the platform 1206 where it is not required). A single bucket of adhesive is mixed (sufficient to adhere ten tactile tiles to the first portion of the installation path) and applied to the first portion of the installation path (within the bounds of the tape) using a trowel. Tactile tiles 1205 are then placed onto the adhesive covered area in a row (running parallel with the platform edge 1203) then pressure is applied downwardly, forcing them towards the floor surface of the platform 1206. In this way the tactile tiles 1205 are securely adhered in place by the adhesive. The tape is then removed from the floor thereby leaving a stretch of ten tactile tiles 1205 installed along the first portion ‘P1’. The shelter system 1201 is held substantially stationary by the brakes whilst the tactile tiles 1205 are installed.

The adhesive used is typically a two-part polyurethane adhesive system which is mixed by a mixer in a container prior to use. In order to mix the two-part adhesive for its subsequent application onto the dry floor area it is important to ensure that all parts of the two-part adhesive within the container are mixed thoroughly and for a suitable length of time. A mixer can be powered by battery or a generator which can be housed within the shelter system 1201. The design of the mixer is specific to the dimensions of the container so that adhesive from the sides and bottom of the container are thoroughly mixed in with the central vortex of the mixer. Operation of the mixer is controlled by a timing switch which is pre-set to control the mixer to mix the adhesive for a specified time which is sufficient to ensure that the two-parts are thoroughly mixed (such that the adhesive fully cures and cross-links). It is preferred to use a Kenwood mixer, or similarly designed food mixers, providing excellent mixing and at the same time allowing buckets to be removed easily by lifting the top of the kenwood mixer upwards.

In a fifth step, the shelter system 1201 is moved along a second portion of the installation path (again, in direction ‘B’) at the prescribed rate such that the heat produced by the heating system dries the floor surface of platform 1206 (sufficiently to allow adhesion of tactile tiles thereto) along the second portion ‘P2’ of the installation path as it is moved along the second portion.

In a sixth step, the brakes are applied to the castor wheels of the shelter system 1201 thereby stopping the shelter system 1201 at a second position (shown in FIG. 12B). In the second position, the first and second shelter sections of the shelter system 1201 are located substantially over the second portion of the installation path ‘P2’ (which has been dried by the heating system).

A further step is shown in FIG. 12C. The above-described process is sequentially repeated until tactile tiles 1205 have been applied along the required length of the platform 1206.

The guide bars 1204 are installed along the full length of the platform 1206. However, a single guide bar could be used and installed and removed as required ‘on-the-fly’ (i.e. installed along a first portion such that the first portion can be dried; removed after tactile tiles have been installed to the first portion; then, installed along a second portion, and so on.

A roller can be fixed to back of the shelter system 1201 relative to the direction of travel along the installation path (i.e. at the opposite end to the heating section). The roller is configured to apply pressure to the tactile tiles that have been adhered to the installation path to ensure that sufficient contact is made between the tactile tiles 1205 and the floor surface of the platform 1206.

The roller can be made from metal, wood, plastic or composite material. To ensure that all the areas of the mat are pressed down evenly a foam rubber is adhered to the roller. The depth of the foam rubber should be sufficient that when compressed under the weight of the roller the compressed height is greater than 6 mm (the height of the tactile profiles) so that it evenly distributes the weight over the entire tactile tile.

Preferably, the roller is arranged such that it is greater than (or equal to) 4 meters behind the shelter system 1201 (with respect to the direction of travel), to allow sufficient time for the adhesive to become tacky. In this way, when the roller passes over the tactile mat, with the tacky adhesive underneath, the mat is pushed onto the tacky adhesive to create an irreversible bond.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A tactile floor surface comprising one or more tactile profiles protruding from the floor surface,
each tactile profile comprising:
a first layer, and
a second layer positioned over the first layer, wherein
the first layer has a visibly distinguishable property such that, in use, when the second layer wears away, the visibly distinguishable property is revealed.

2. A tactile floor surface according to claim 1, wherein the first layer of each tactile profile protrudes a first predetermined amount above the floor surface.

3. A tactile floor surface according to claim 2, wherein the first predetermined amount is such that each tactile profile is substantially detectable under foot.

4. A tactile floor surface according to claim 3, wherein the first predetermined amount is a distance of approximately 3 mm above the floor surface.

5. A tactile floor surface according to claim 1, wherein the visibly distinguishable property is a colour which is different from a colour of the second layer.

6. A tactile floor surface according to claim 1, wherein either, or both, the first layer and the second layer comprise a polymer either with or without an aggregate.

7. A tactile floor surface according to claim 6, wherein the polymer comprises polyurethane.

8. A tactile floor surface according to claim 6, wherein the aggregate comprises glass beads, aluminum oxide, or quartz either individually or as a mix.

9. A tactile floor surface according to claim 1, wherein the tactile floor surface is a tactile tile.

10. A tactile floor surface according to claim 9, wherein the tactile tile is a surface mountable tactile tile.

11. A tactile floor surface according to claim 1, wherein the one or more tactile profiles are blister profiles.

12. A tactile floor surface according to claim 1, wherein the one or more tactile profiles are corduroy profiles.

13. A tactile floor surface according to claim 1, wherein the one or more tactile profiles are guidance profiles.

14. A tactile floor surface according to claim 1, wherein the one or more tactile profiles are configured to be used in conjunction with a segregated path comprising a foot path and a cycle track.

15. A tactile floor surface according to claim 14, wherein the one or more tactile profiles are configured to highlight the cycle track.

16. A tactile floor surface according to claim 1, wherein the second layer of one or more of the one or more tactile profiles comprises glow-in-the-dark material.

17. A tactile floor surface according to claim 16, wherein the one or more tactile profiles comprising glow-in-the-dark material are arranged to indicate a pathway on the floor surface.

18. A tactile floor surface according to claim 16, wherein the one or more tactile profiles comprising the glow-in-the-dark material are arranged to indicate hazards such as a platform edge, a cycle route, or a change in height of a floor surface.

19. A tactile profile for use in a floor surface according to claim 1, the tactile profile arranged to protrude from a floor surface, said tactile profile comprising:
a first layer, and
a second layer positioned over the first layer, wherein
the first layer has a visibly distinguishable property such that, in use, when the second layer wears away, the visibly distinguishable property is revealed.

20-78. (canceled)
